(19) United States
(12) Patent Application Publication
(10) Pub. No.: US 2008/0262928 A1
(43) Pub. Date: Oct. 23, 2008

(54) METHOD AND APPARATUS FOR DISTRIBUTION AND PERSONALIZATION OF E-COUPONS

(76) Inventor: Oliver MICHAELIS, San Diego, CA (US)

Correspondence Address: QUALCOMM INCORPORATED, 5775 MOREHOUSE DR., SAN DIEGO, CA, 92121, US

(21) Appl. No.: 12/104,840

(22) Filed: Apr. 17, 2008

Related U.S. Application Data
(60) Provisional application No. 60/912,621, filed on Apr. 18, 2007.

(51) Int. Cl. G06Q 30/00

(52) U.S. Cl. 705/14

(57) ABSTRACT

A method and system for distributing and personalizing E-Coupons include sending a generic E-Coupon identifier to a mobile device and requesting a redeemable personalized E-Coupon based on the generic E-Coupon identifier. User location, time, purchase history and preference may be provided and used to personalize the E-Coupon. The personalized E-Coupon may then be distributed to the mobile device. The generic E-Coupon identifier may be distributed through different media, such as audio, video, multimedia or wireless data networks. For high security devices, the personalized E-Coupon may be sent digitally signed. For low security devices, the E-Coupon Manager may store the personalized E-Coupon and send to the mobile device a unique E-Coupon ID. The distributed personalized E-Coupons may be used to receive discounts at a merchant physical location or Internet site.

### RELATED APPLICATIONS

The present application claims the benefit of priority to U.S. Provisional Patent Application No. 60/912,621 filed Apr. 18, 2007 entitled “Method and Apparatus for Distribution and Personalization of e-Coupons,” the entire contents of which are hereby incorporated by reference.

### FIELD OF THE INVENTION

The present invention relates generally to electronic coupons, and more specifically to distribution and personalization of electronic coupons.

### BACKGROUND

Manufacturers and retailers use coupons as a mode of advertising and discounting their products to compete with other similar products in the market. Today, coupons are distributed to consumers as paper coupons, TV and radio promotions, and electronic coupons (E-Coupons). Currently available coupons and their distribution methods have proved to be inefficient for coupon owners and difficult and inefficient for consumers to redeem. As a result, manufacturers, service providers and retailers experience low rates of response to their coupons, or put another way, spend unnecessary effort distributing coupons that will not be redeemed just to be able to reach the consumers who will redeem their coupons.

Paper coupons involve printing and handling costs, are non-specific and yield low rates of return on investment for coupon owners. Also, handling paper coupons impose handling difficulties on consumers and merchants. TV and radio promotions lack target specificity and are difficult for both consumers and manufacturers to track. Existing E-Coupons also lack specificity and require that consumers spend time searching for E-Coupons on the Internet.

### SUMMARY

The various embodiments provide methods and systems for personalizing and effectively and efficiently distributing E-Coupons. Distributing personalized E-Coupons may be achieved in a multistep process. A generic E-Coupon identifier may be sent to a mobile device to retrieve consumer and device specific data. Using this data the E-Coupon can be personalized and distributed to the consumer. Such consumer specific data may include consumer location, time, consumer behavior, consumer environment, consumer purchase history, and/or mobile device specifications. Such personalized E-Coupons can be user- and device-specific, effective and easier to redeem and manage.

In the various embodiments, E-Coupons may employ a variety of communication media, such as audio, video, telecommunication, Internet, Smart Ads and radiofrequency Tags. The use of such distribution media enable more accurate targeting and localization of consumers, and consequently provide more efficient tools for creating and distributing personalized E-Coupons to consumers of most interest to coupon owners. Furthermore, well-targeted coupons find higher acceptance with consumers and enhance advertisement efficiency and brand image

E-Coupons may be distributed differently depending upon the security level of receiving mobile devices. Mobile devices with high security levels may receive E-Coupons protected by encryption and/or digital signatures. Mobile devices with low security levels may receive E-Coupon identifiers (ID) linked to an E-Coupon stored on an external secure server for future retrieval.

In the various embodiments, E-Coupons redemption may employ variety of data communication technologies, such as near field wireless communication data links, far field and wide area wireless communication data links, and/or simple bar code scanning technologies. In an exemplary embodiment, a near field communication data link may be used to redeem E-Coupons and restore E-Coupons on the mobile devices when payment transactions fail.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1 is a system block diagram of prior art paper coupon distribution methods.

FIG. 2 is a system block diagram of an embodiment for distributing and personalizing E-Coupons.

FIG. 3 is a system block diagram of an exemplary embodiment for personalizing and distributing E-Coupons.

FIG. 4 is messaging diagram of an embodiment for distributing and personalizing E-Coupons.

FIGS. 6A and 6B are message structure diagrams suitable for use in an embodiment.

FIG. 5 is a process flow diagram of an embodiment for distributing and personalizing E-Coupons.

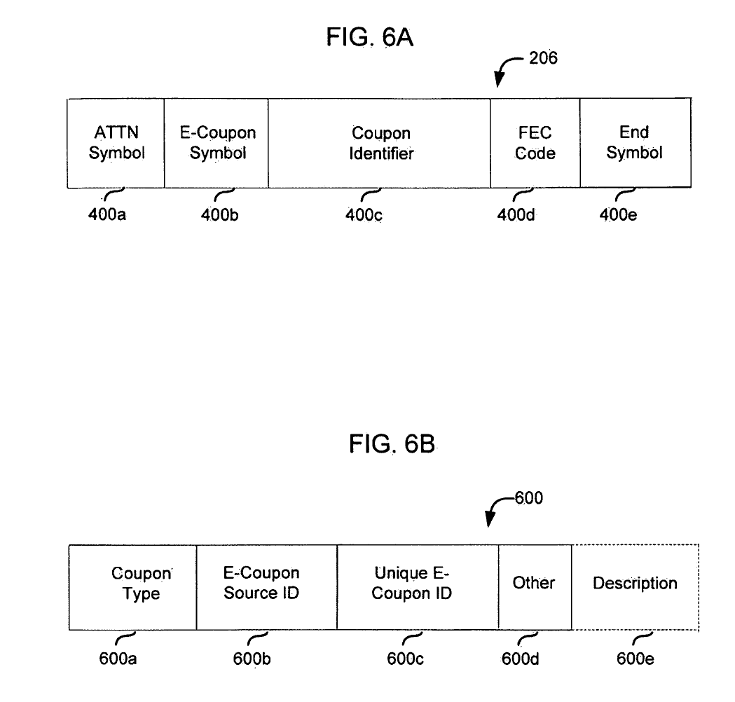

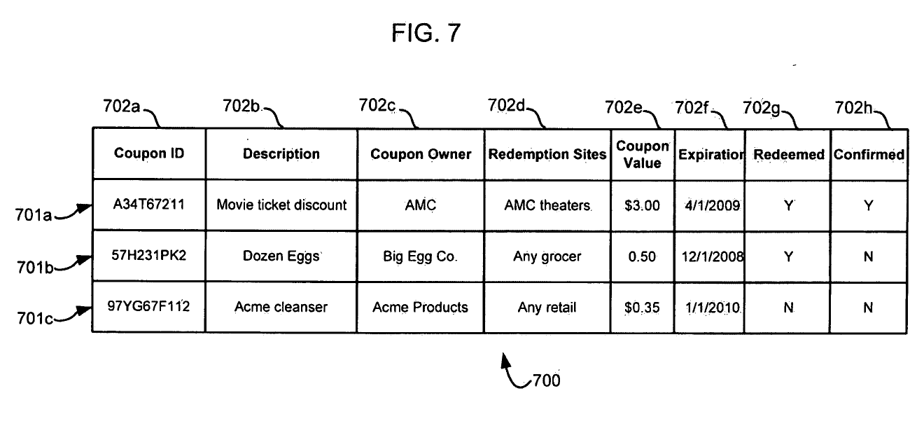

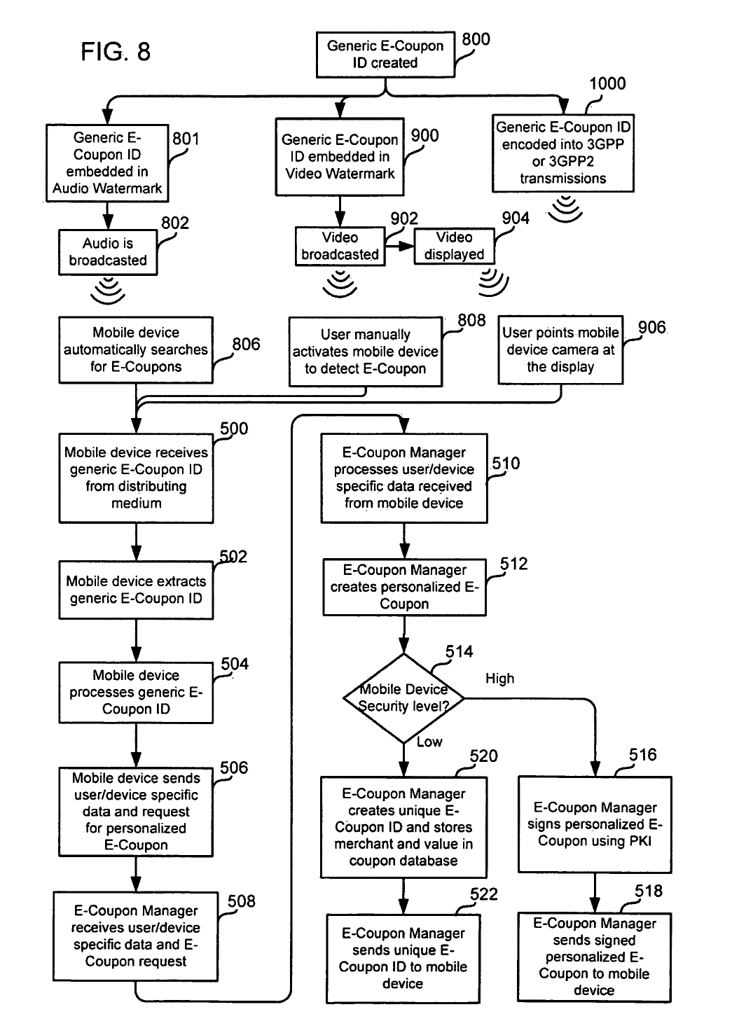

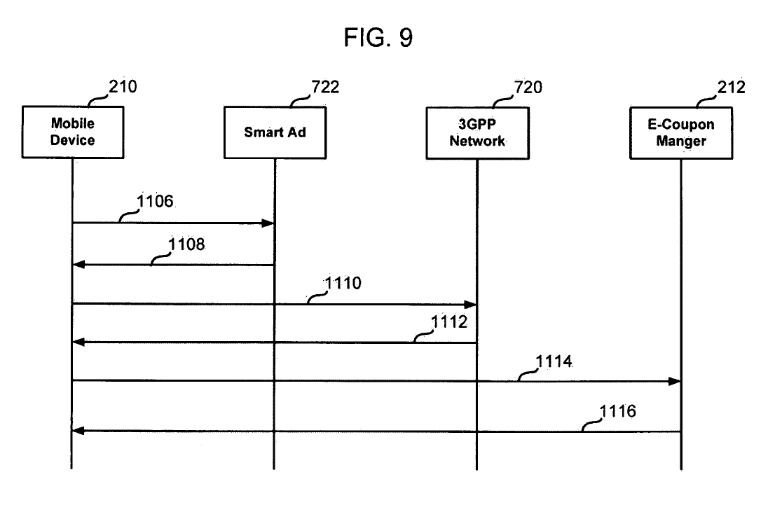

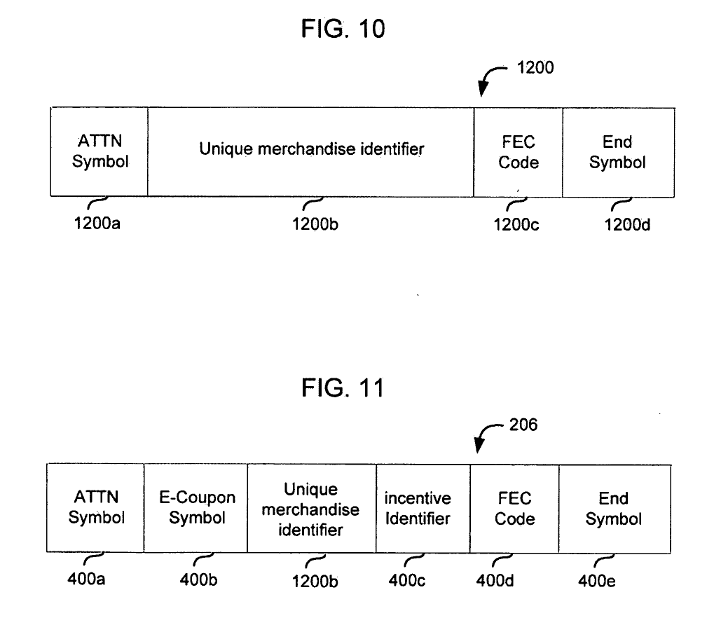

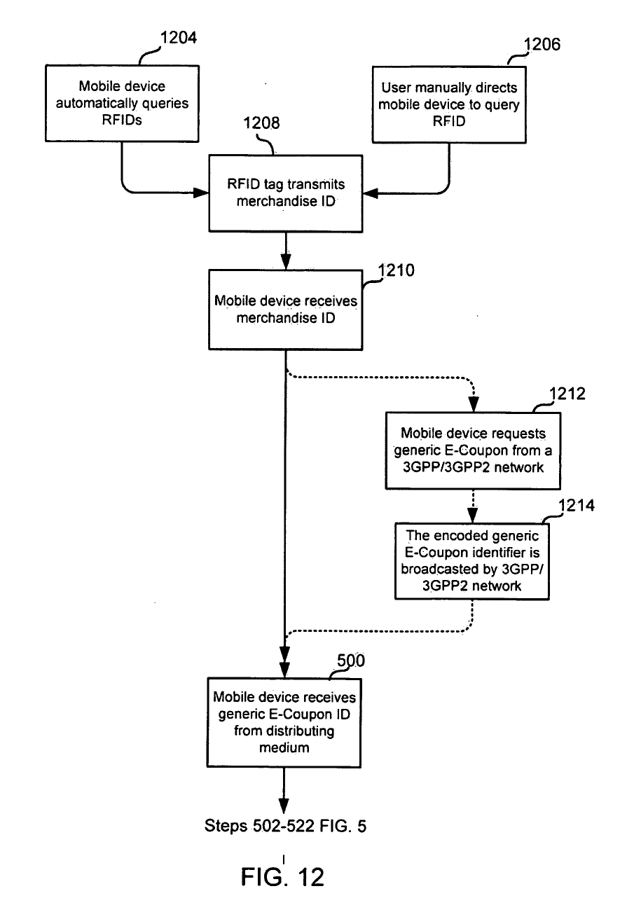

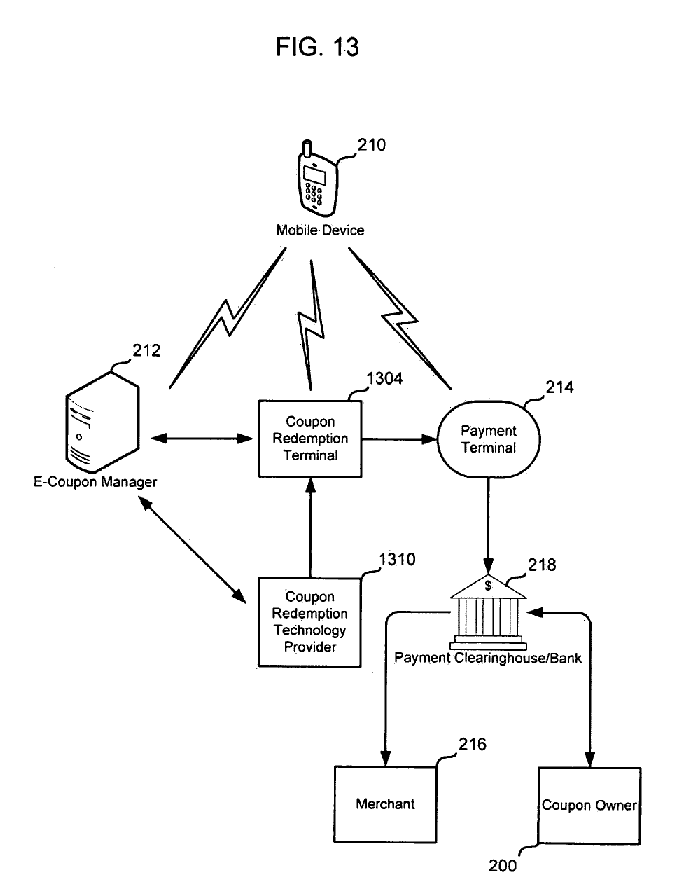

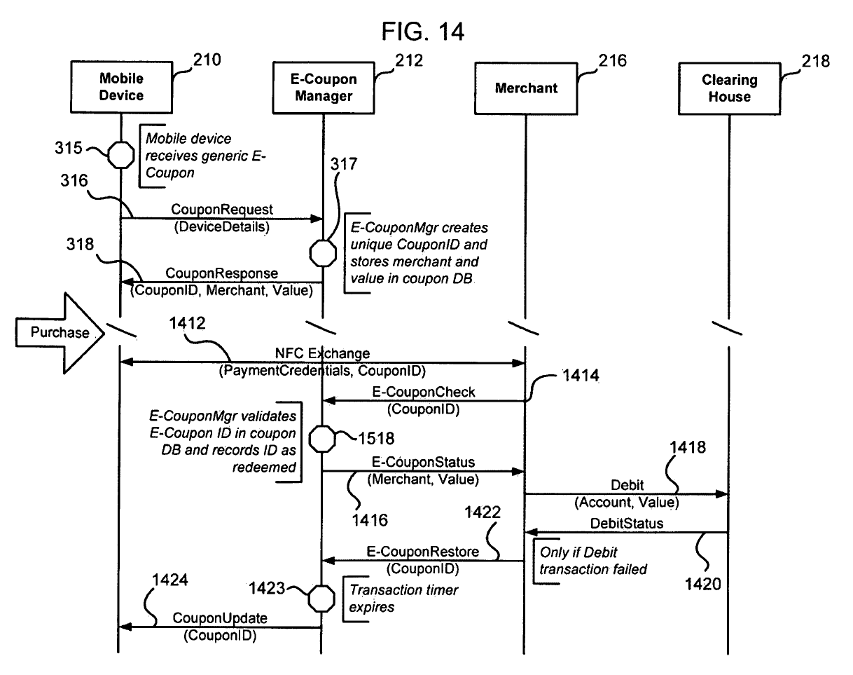

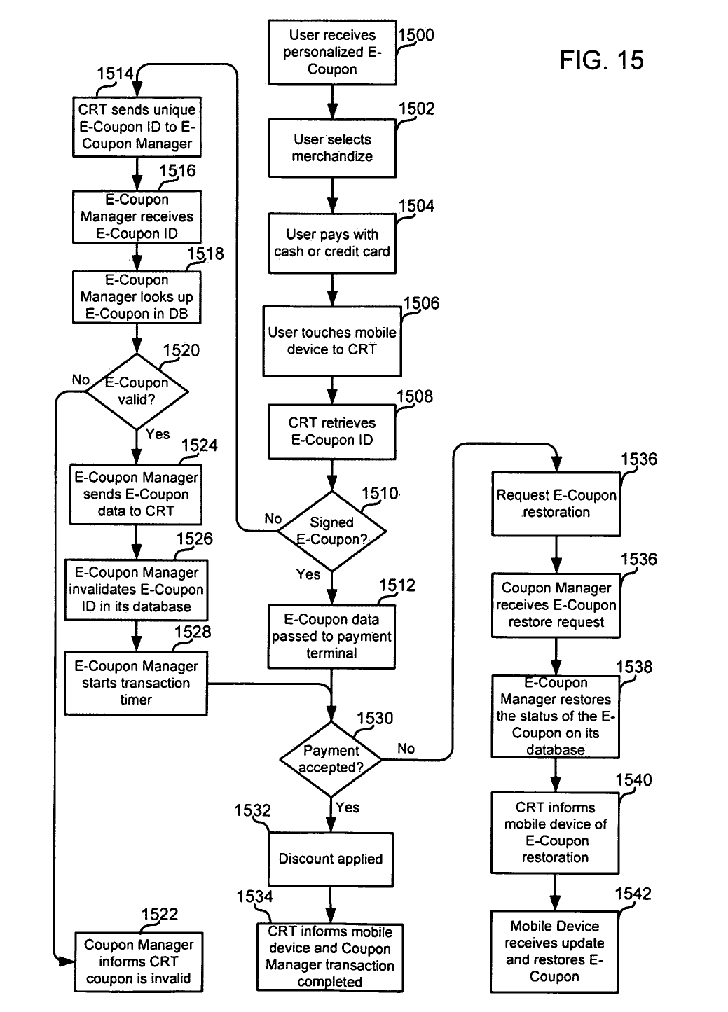

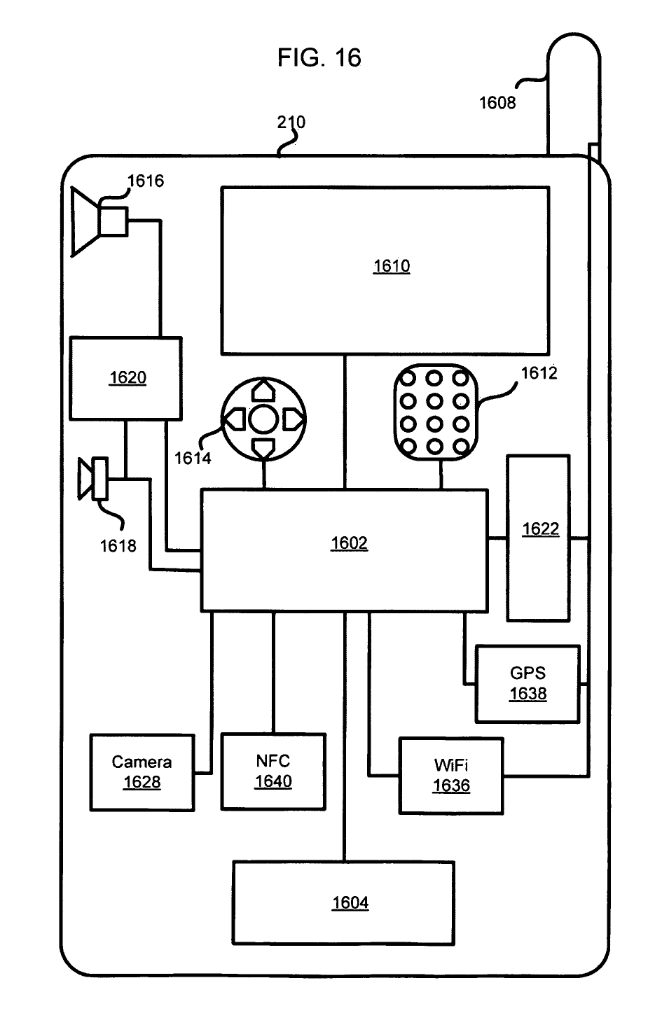

FIGS. 6A and B are message structure diagrams of an exemplary embodiment for distributing personalized E-Coupons.

FIG. 7 is a data structure diagram of an embodiment for storing E-Coupons in the memory of a mobile device.

FIG. 8 is a process flow diagram of exemplary embodiments for personalizing and distributing E-Coupon.

FIG. 9 is a messaging diagram of an exemplary embodiment for personalizing and distributing E-Coupons using smart chip technology.

FIGS. 10 and 11 are message structure diagrams of an exemplary embodiment for distributing personalized E-Coupons using smart chip technology.

FIG. 12 is a process flow diagram of an exemplary embodiment for personalizing and distributing E-Coupons using smart chip technology.

FIG. 13 is a system block diagram of an embodiment system for redeeming E-Coupons.

FIG. 14 is a messaging diagram of an embodiment for redeeming E-Coupons.

FIG. 15 is a process flow diagram of an exemplary embodiment for redeeming E-Coupons.

FIG. 16 is a component block diagram of mobile handsets suitable for implementing the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

In this description, the terms “incentive,” “coupon” and “promotion” are used interchangeably to refer to a variety of marketing and promotional incentives. The word “exemplary” is used herein to indicate an example, instance, or illustration and not a necessary implementation or element. Any implementation described herein as “exemplary” is not necessarily to be construed as preferred or advantageous over other implementations.

As used herein, the term “server” refers to any of a variety of commercially available computer systems configured to operate in a client server architecture. In particular, the term “server” refers to network servers, particularly Internet accessible servers, which typically include a processor, memory (e.g., hard disk memory), and network interface circuitry configured to connect the server processor to the network, such as the Internet. The server may also include specialized hardware for security purposes.

In this description, the terms “mobile device,” “communication device,” “wireless device,” “wireless telephone,” “wireless communications device” and “wireless handset” are used interchangeably to refer to any of a variety of mobile or personal electronic devices including some or all of the capabilities described herein. In particular, these terms may refer to any one or all of cellular telephones, personal data assistants (PDA's), palm-top computers, laptop computers, wireless electronic mail receivers (e.g., the Blackberry® and Treo® devices), multimedia Internet enabled cellular telephones (e.g., the iPhone®), and similar personal electronic devices, as well as near-field purchasing (NFC) devices (e.g., an NFC equipped credit card or key chain fob), all of which include a programmable processor and memory. In a preferred embodiment, the mobile device is a cellular handset that can communicate via a cellular telephone network (e.g., a cellphone). With the advent of third generation (3G) wireless technology, more bandwidth availability has enabled more electronic devices with wireless capabilities. However, cellular telephone communication capability is not necessary in all embodiments. Moreover, wireless data communication may be achieved by the mobile device connecting to a local or wide area wireless data network (e.g., a local or wide area WiFi network) instead of a cellular telephone network.

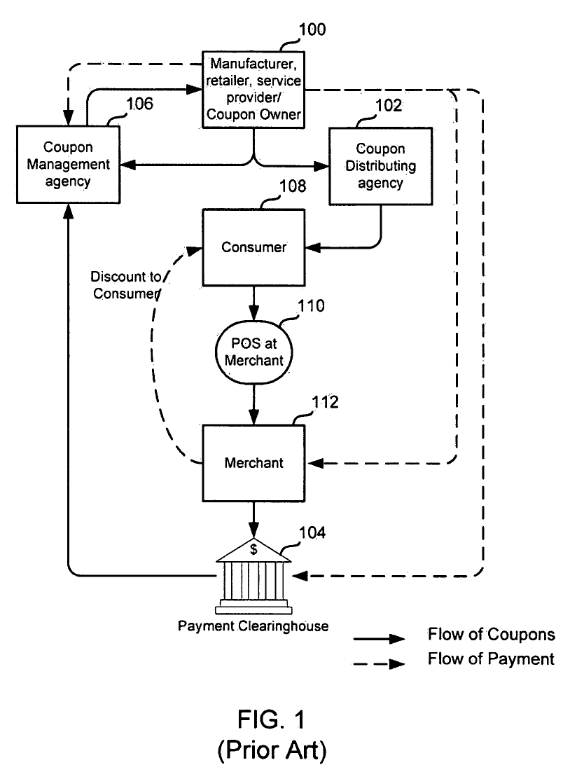

As illustrated in FIG. 1, with paper coupons, manufacturers, retailers and service providers (“coupon owners”) 100 may need to hire a coupon distributing agency 102, a clearinghouse 104, and a coupon management agency 106 to manage and distribute its coupons. The coupon distributing agency 102 prints and distributes paper coupons to consumers 108. Typically paper coupons are distributed by direct mail, fliers handed out at retailers and in print media, such newspaper and magazine inserts and advertisements. To find coupons, consumers must sift through volumes of paper, and expend effort clipping, sorting and keeping track of their paper coupons. At the point-of-sale 110, consumers present to the merchant 112 the paper coupon corresponding to the goods or services being purchased. Upon checkout, the merchant 112 scans or manually records the paper coupon and discounts the consumers' purchase price accordingly. The merchant 112 collects paper coupons from many customers, and periodically bundles and sends the coupons to the clearinghouse 104 for processing. The clearinghouse 104 manually sorts, counts and inventories the paper coupons. The clearinghouse 104 then prepares redemption payment invoices and forwards the invoices and the paper coupons to each manufacturer's coupon management agency 106. The manufacturer's coupon management agency 106 then provides the manufacturer 100 with redemption volume data, redemption payment data and the physical coupons to be destroyed. The manufacturer 100 then remits payment for services to the manufacturer's coupon management 106 and clearinghouse 104 and pays the merchant 112 for the face value of the coupons plus a handling fee per coupon.

As this process description reveals, paper coupons are costly and inefficient to print, distribute, handle and clear paper coupons. Manufacturers incur high costs printing and distributing approximately 300 billion coupons per year. Since the vast majority of coupons do not target specific consumers, manufacturers receive low rates of return on this investment (ROI) since only approximately 1% of circulated coupons are redeemed on average. Low coupon response rates can be attributed in part to not getting the right coupons into the hands of the right consumers. For example, consumers who do not own pets have little interest in coupons for pet products, yet they receive dozens of such coupons in the mail and in magazines and newspapers every week. Low coupon redemption rates may also be due to the difficulty of finding, clipping, sorting and managing paper coupons. Consumers may not find coupons before shopping, may fail to use them in time, or forget to use them altogether.

The cost of printing, handling and clearing paper coupons is high because manufacturers must pay to have coupons printed and distributed, pay merchants and the clearinghouse for processing the coupons, and then incur further costs destroying the coupons. Beyond such printing and handling costs, distributing paper coupons is also costly because manufacturers must circulate their coupons in different print media to reach consumers in different demographic segments. For example, pet owners are in all demographic segments, and thus cannot be reached through media focused on any single economic, social or interest segment. Additionally, manufacturers receive very little feedback from consumers as the coupon system provides them with very little information regarding where, how, when, why and by whom coupons were used. TV and radio promotions also have limited capabilities to target specific consumers. As such, advertising dollars are wasted on distributing coupons to consumers who have no interest in the particular products, stores or services.

Currently available electronic coupon (E-Coupons) systems have addressed some but not all the problems of paper coupons. To use E-Coupons, consumers search the Internet to find E-Coupons for specific products. Once an E-Coupon is found, the consumer may print the E-Coupon or store it on a mobile device to be used at a merchant. At the point-of-sale, the merchant enters a number associated with the E-Coupon into its system, issues a discount to the consumer and invalidates the E-Coupon number in its system.

While E-Coupons reduce coupon owners' printing and handling costs, E-Coupons have other problems. To obtain E-Coupons, consumers must engage in the difficult step of searching for E-Coupons on the Internet. Thus, consumers must know the nature and specifications of the merchandise or service for which they are searching. E-Coupons also depend on consumers having access to the Internet, be proficient Internet searchers and have the patience to sift through myriads of websites in their search for E-Coupons. As a result, E-Coupons are difficult for consumers to find and have a low rate of redemption, and therefore are an imperfect mode of incentivizing consumers.

To overcome these limitations of current coupon systems, the various embodiments provide methods and systems for distributing personalized E-Coupons to targeted consumers and providing easy-to-use redemption solutions. Using the various embodiments, manufacturers can personalize their E-Coupons and distribute them to specific targeted individual consumers based on their location, chronology, purchasing behavior, user environment, etc. This specificity in providing E-Coupons to selected consumers at a time and place where consumers are most likely to redeem the coupon eliminates aimless mass distribution of coupons reducing the cost of this form of advertising compared to currently available coupon systems. Moreover, when consumers receive a personalized E-Coupon, the rate of response is expected to be high because the coupons are ready for redemption when received so consumers no longer have to engage in cutting or storing paper coupons, memorizing or recording TV or radio promotion codes, or expend valuable time in searching for E-Coupons on the Internet. Easy-to-use redemption solutions also enhances consumers' rate-of-respond to E-Coupons.

In overview, the various embodiments deliver a generic E-Coupon, such as in the form of a generic E-Coupon identifier (ID), to mobile devices using one or more of a variety of transmission media, particularly media that are localized or localizable. Mobile devices can receive and recognize the generic E-Coupon ID. Then using information in the generic E-Coupon ID and another communication link transmit, the mobile device can transmit the generic E-Coupon ID and, optionally, information regarding the user and the mobile device, to a system which can craft and return a personalized E-Coupon which can be redeemed. For example, the generic E-Coupon ID may be an Internet protocol (IP) address or URL that the mobile device can use to contact an E-Coupon Manager and request a redeemable and personalized E-Coupon. By making use of unconventional communication media and the processing power of mobile devices and external servers, personalized and targeted E-Coupons can be delivered to consumers in an efficient manner.

Mobile devices have or can be equipped with a variety of sensors and receivers which can be used to receive information, including a generic E-Coupon ID. Of course, most mobile devices are equipped with a cellular telephone transceiver, many include a local-area wireless transceivers such as a Bluetooth® transceiver, and some include WiFi transceivers. In addition, mobile devices typically include a microphone for use in telephony and recording sounds, and many include digital cameras. Some mobile devices include FM radios and even television receivers. Mobile devices may also be equipped with near field communication transceivers. Each of these sensors and transceivers may be used as communication links in the various embodiments to receive generic E-Coupons. Of particular advantage in some embodiments are audio (i.e., sound) and video sensors and local area/near-field transceivers which can only receive information from close-by sources, thereby localizing the mobile device at the time of reception.

In an embodiment, perceptual media like sound (“audio”) (e.g., music and inaudible sound) and visual displays (e.g., static images and television or computer monitor displays) can be used to communicate a generic E-Coupon ID 206 to mobile devices 210. Audio and visual distribution methods offer a number of advantages for distributing generic E-Coupons. For one, these media are localized, enabling the generic E-Coupon to be very location unique. For example, audio programs, such as piped in music are typically limited to a particular store or even a particular section or floor of a store or mall. Mobile devices 210 must be close to the speakers to receive the sound, thereby pinpointing the location of the user at the time the generic E-Coupon 210 is delivered. As another example, visual distribution methods are even more local, as users must be standing nearly directly in front of the display in order to record the image on their mobile device 210.

Another advantage of using perceptual media for communicating generic E-Coupons is that these media are unregulated by the FCC so there is no need to obtain spectrum. On the other hand, in most cases the amount of data transmitted over perceptual media will be limited in order to keep the information imperceptible. The various embodiments accommodate this limitation by using perceptual media to communicate the generic E-Coupon ID, which can be a small amount of data.

A simple message like a generic E-Coupon ID can be embedded in audio, such as background music, using digital watermarking technologies. Digital audio watermarking involves the concealment of data within a discrete audio file. A digital watermark is a signal that can be detected and extracted by a processor configured to recognize and interpret the pattern. For example, a watermark embedded within an audio stream can be used to identify its origination. Watermarks are inaudible and can be robust and easily identifiable by electronic processing. Methods for embedding data as a digital watermark in a medium are well known in the art. See e.g., D. Kirovski and H. S. Malvar, Spread Spectrum Watermarking of Audio Signals, IEEE Transactions on Signal Processing, Vol. 51, (no. 4), pp. 1020-33, 2003. In addition to identifying source, simple information may be embedded in the signal, such as a URL or identifier of limited length that can be used as a generic E-Coupon ID. Using digital watermark technology, generic E-Coupon identifiers 206 may be embedded in audio or video transmission and broadcasted to mobile devices 210.

Audio watermark signals can be detected by mobile devices using their built in microphone, such as the microphone used for telephony or for recording sounds. By monitoring signals received by the microphone, a processor within the mobile device configured with software to detect and recognize watermarks can receive data signals embedded in the audio. Thus, while consumers are entertained by music playing within a store in which they are shopping, their mobile device may be receiving and processing digital communications embedded within the music. Such embedded information may be repeated over and over, such as one or a few generic E-Coupon IDs, or comprise an extended data stream including a number E-Coupon IDs.

Similarly, a generic E-Coupon ID can be embedded in images and video displays using digital watermarking. A video digital watermark may be formed of embedding subtitles or patterns that are imperceptible but readable by a digital camera and processor. If the video is received as a television signal, the watermarking may be included in the closed captioning information.

Visual watermarks can be detected by mobile devices using image detecting components, such a built-in camera. While the watermark may be embedded so that it is imperceptible to humans, a digital image may be analyzed using known methods to recognize and interpreting a digital watermark, including a watermark embedding a generic E-Coupon ID. Visual watermarks may be incorporated into a static image, like a photograph, poster or advertisement. Visual watermarks may also be incorporated within video images, such as videos presented on a monitor (e.g., television) or projected onto a surface. As with audio watermarking, one or a few generic E-Coupon IDs may be embedded in a visual image (e.g., picture) or repeated in a video stream, or comprise an extended data stream within a video stream including a number E-Coupon IDs.

Another visual communication method that can be used for delivering generic E-Coupons involves encoding data into light, such as overhead, spot lights or back lights of displays. By flashing or varying the intensity of such lights, data signals can be encoded into the light, such as in the form of sequences of on and off lights, or varying intensity. For example, the signaling light may be at a frequency invisible to humans but detectable by digital camera on a mobile device. Alternatively, the rate of flashing or brightness variations may be at a rate faster than perceived by humans (e.g., at intervals less than about a tenth of a second) but easily detected by digital cameras.

A well known visual communication method that may be used with various embodiments is a barcode or two-dimensional bar code. As is well known, bar codes are imageable patterns that encode a number. In an embodiment, a generic E-Coupon ID may be encoded in a barcode appearing in an advertisement, display, on product packaging, or shelving near the product. A mobile device can be configured to receive the generic E-Coupon ID by imaging the barcode with a built in camera and then processing the digital image using software running on a processor in the device.

Using such perceptible media (i.e., sound or light) to communicate a generic E-Coupon ID enables mobile devices to receive localized and targeted personalized E-Coupons. In order to receive the generic E-Coupon ID the mobile device must necessarily be within audio or visual range of the source. Thus, when the mobile device forwards the generic E-Coupon ID to a coupon manager in order to obtain a redeemable E-Coupon, the coupon manager can be informed of the specific location of the mobile device (at least at the time the generic E-Coupon ID was received). Such localizing information can be very helpful in crafting a personalize E-Coupon since the location of the consumer at a particular time can enable E-Coupons to be personalized to merchandise or services that are immediately available to the consumer at the time.

In other embodiments, mobile devices can receive a generic E-Coupon ID from radiofrequency data links, including wide area (far field) wireless data links, like cellular, WiFi, WiMAX, local area wireless data links, like Bluetooth® and Zigbee® protocol communication links, and short range or near field communication (NFC) communication links. In such embodiments, a source of generic E-Coupons may establish a wireless communication link with a mobile device within range using any known protocol or handshaking process associated with the particular communication technology. Once the link is established, the generic E-Coupon can be communicated to the mobile device, which can then use the information to contact the E-Coupon Manager to request a redeemable, personalized E-Coupon. With the large bandwidth of such wireless communication links, the generic E-Coupon communication may include more information than a simple ID or address, and may convey a large number of generic E-Coupons that may be browsed and sorted on the mobile device. Also, in some implementations the mobile device may use the same wireless communication link to request the redeemable E-Coupon or E-Coupons.

Most wireless communication technologies (excluding satellite-based communication technologies) are necessarily localized within the communication range of a base station or transceiver. Thus, a generic E-Coupon delivered by a wireless communication link can provide some localization information. By reducing the transmission power of the generic E-Coupon source wireless transceiver, the delivery of the generic E-Coupon can be used to provide localizing information within a small range. For example, by using local area wireless network technologies, such as low power 802.11g protocol transceivers, a mobile device receiving a generic E-Coupon source as passing close by a billboard, within the walls of a store or even within departments of a large store.

Satellite-based communication technologies which have large communication footprints typically are subscription based, using subscriber IDs to control access to the signals. Therefore, even though satellite communications technologies such as satellite radio and satellite television services are not localized, the information known to the communications provider (e.g., Sirius Satellite Radio, Inc. or The DirecTV Group, Inc.) can be used to localize the consumer as well as provide additional information to enable the delivery of personalized generic E-Coupons. Thus, wide-area subscription based communication technologies can be used to deliver generic E-Coupons in a manner similar to those of the embodiments described herein.

In an embodiment, the mobile device may include a transceiver configured to read radiofrequency identification (RFID) tags included in products and displays. RFID tags are a type of near field communication device in which the tag is powered by RF energy from a reader (e.g., by rectifying the received RF energy) and configured to transmit a short data packet containing a unique identifier. Most RFID tags contain at least two parts. One is an integrated circuit for storing and processing information, modulating and demodulating a (RF) signal and performing other specialized functions. The second is an antenna for receiving and transmitting the signal. A simple memory card type RFID can return a ID value without the complexity of an integrated processor circuit, thereby allowing tags to be printed directly onto goods at lower cost than traditional tags. The RFID reader can receive the identifier data and use the ID to look up information associated with the tag in a database. Since RFID tags transmit information they are sometimes referred to as smart tags. Thus, a mobile device configured with an RFID reader transceiver can query an RFID tag, and then send the received identifier to an E-Coupon manager to request a redeemable coupon for the product associated with the RFID tag. RFID tags are included in many products, and may also be included in display advertisements. Since the effective transmission range of most RFID tags is limited, advertising displays may prompt consumers to touch their mobile device to a part of the display including an RFID tag to receive valuable E-Coupons. When consumers touch or bring their mobile device close to the RFID tag, the identifier information is transferred and the mobile device can then request and receive a localized, personalized E-Coupon. Near field communication transceivers have similarly short effective ranges and so may be used in a similar manner.

In another embodiment, a consumer using a computer or a mobile device may obtain a generic E-Coupon by contacting a server via a network, such as the Internet. Once the generic E-Coupon has been received via the network (e.g., by way of an HTML sequence delivered to the consumer's browser), the computer or mobile device may request a personalized redeemable E-Coupon according to the various embodiments described herein.

Using the various embodiments, E-Coupons can be personalized and delivered to a consumer based on a variety targeting criteria not possible with other couponing systems. In particular, E-Coupons may be personalized based on, for example, a) location (with high accuracy); b) time; c) consumer purchase history, d) consumer behavior and interests, and e) mobile device specification. Each of these criteria are described separately in the following paragraphs, but may also be combined or considered as a whole to even more closely personalize coupons for particular consumers. The types of information useful for personalizing E-Coupons listed above and described below are not meant to be exclusive and many other types of information may also (or alternatively) be used to personalize E-Coupons using methods similar to those in the embodiments described herein.

Location-dependent E-Coupons are coupons delivered to individual consumers because their location makes them likely to be interested in the product or service or more likely to use the coupon, such as when the consumer is at or near a place of redemption. For example, a location-dependent E-Coupon may be issued and distributed to consumers when they drive past a particular shopping mall, walk past an particular advertisement billboard, enter a specific store or sift through specific merchandise within a store. Location-dependent E-Coupons may be issued for merchandise or services available at the location, thereby incenting consumers to make an immediate purchase. Also, location-dependent E-Coupons may be issued to consumers because their location indicates that they are likely to be interested in particular goods or services, such as coupons for pet supplies delivered to consumers attending a dog or cat show. The value of the coupon incentive may also be varied or set depending on the location where the E-Coupon is redeemed. For example, different stores may offer different discounts on the same merchandise based on the same E-Coupon. Depending on which store processes the E-Coupon, the value of that E-Coupon may vary.

Time-dependent E-Coupons are coupons delivered to individual consumers at particular dates and times to (or with specific redemption periods) when consumers are more likely to be interested in the products or services. Using time-dependent E-Coupons, merchants can issue E-Coupons that are redeemable in particular store locations at particular times of day or days of week, or month or year. For example, merchants may issue time-dependent E-Coupons crafted to attract consumers at times and days during which sales often lag. As another example, coupon owners may issue seasonal E-Coupons crafted to prompt consumer purchases based on the calendar date. As another example, restaurants and fast food establishments may deliver E-Coupons for particular meals, since consumers are more likely to redeem a coupon for breakfast that is delivered early in the morning than at another time of day. Different stores may offer sales for the same merchandise on different dates. Therefore, time-dependant E-Coupons may automatically adjust according to targeted specific times for each store.

Purchase-dependent E-Coupons are coupons delivered to individual consumers based on the consumers' past purchasing history or a current transaction. Coupons printed at the cash register at check out for items similar to those just purchased is an example of prior art purchase-dependent coupons; however, such coupons are inherently delivered too late to influence the consumers' present purchases. Due to privacy concerns, consumers' purchasing history and similar personalized information is typically not available in advance to merchants, manufacturers or coupon distribution agents in traditional coupon channels. Currently VISA®, MasterCard®, and AMERICAN EXPRESS® offer consumers entertain award programs with the awards based on the transaction history. However, these incentives are location and time independent because they are typically based on the credit card monthly account statement. Purchase-dependent E-Coupons of the various embodiments enable real-time personalization and targeting of E-Coupons to consumers. For example, consumers who purchase baby formula on a weekly or monthly basis and who permit their purchase history to be provided to coupon issuers (as described herein) may receive baby formula E-Coupons when they enter a shopping center or supermarket. In contrast, consumers who purchase pet products regularly may be sent E-Coupons for pet products, such as when consumers drive past a pet store. This capability of distributing E-Coupons based on consumer needs and purchasing history helps to ensure consumers only receive E-Coupons in which they are most likely to be interested. From the coupon owner's perspective, providing E-Coupons to consumers based on their needs and purchasing history enables the coupon owner to measure the effectiveness of E-Coupons for particular consumers based upon their redemption periodicity and frequency.

Behavior-dependent E-Coupons are coupons delivered to individual consumers based on their hobbies, interests, and general behaviors. For example, a consumer playing a game on a mobile device may be used to trigger issuance of E-Coupons related to gaming merchandise, tickets, events, etc. Internet web browsing on the mobile device can also be leveraged for customizing E-Coupons based upon the websites accessed and the amount of time spent on each. If a consumer has used a mobile device to browse web sites related to music stores and pianos, for example, an E-Coupon for a piano or piano tuning services may be sent to the consumer, such as when the consumer is close to a music store.

Mobile device-dependent E-Coupons are coupons delivered to individual consumers in formats customized for or compatible with each consumer's mobile device. For example, if a mobile device is capable of receiving images, then an E-Coupon may be sent to the mobile device as a picture with design, color and format. If the mobile device is unable to view images, the E-Coupon may be sent in text format. E-Coupon content or design may also be varied based on the information received from different sensors on a mobile device. Supported payment technologies (e.g., inclusion of an NFC transceiver) and security capabilities (e.g., digital signature and encryption capabilities) may also be used to customize the E-Coupon so that it can be redeemed in the most expeditious manner. A common XML schema definition of mobile device capabilities and protocols may be beneficial for communicating such information and assuring interoperability between different E-Coupon systems.

Environment-dependent E-Coupons are coupons delivered to individual consumers based on the ambient environment as measured or reported by the consumer's mobile device. A mobile device may include sensors or applications capable of measuring or sensing information related to a environment and ambient conditions. For example, mobile devices may include accelerometers, temperature sensors, ambient noise sensors, and a GPS receiver. Information from these sensors can be reported to the E-Coupon Manager to enable it to craft personalized E-Coupons to the consumer's environment. For example, if a consumer visits a gym, the consumer's mobile device may detect and extract a generic E-Coupon IDs embedded in background music. If the person begins jogging, the mobile device 210 may sense this activity as periodic accelerations recorded by an accelerometer. The combination of the consumer's location (obtained from the generic E-Coupon ID for example) and the accelerometer information can be sent to the E-Coupon Manager 212 with a request for a personalized E-Coupon. The E-Coupon Manager 212 may use that information to generate a personalized E-Coupon for running shoes, for example, making the E-Coupon immediately available on the user's mobile device 210.

As another example, if the device is equipped with an ambient temperature sensor and the consumer is in a cold climate, E-Coupons sent may be sent for a hot drink, a warm jacket, ski lift tickets, etc. Also, the E-Coupon design may be customized based on such information, such as, for example, including a hot red background on E-Coupons issued to consumers whose mobile device is cold and a cool blue background on E-Coupons issued to consumers whose mobile device hot, based upon the temperature reported by the mobile device.

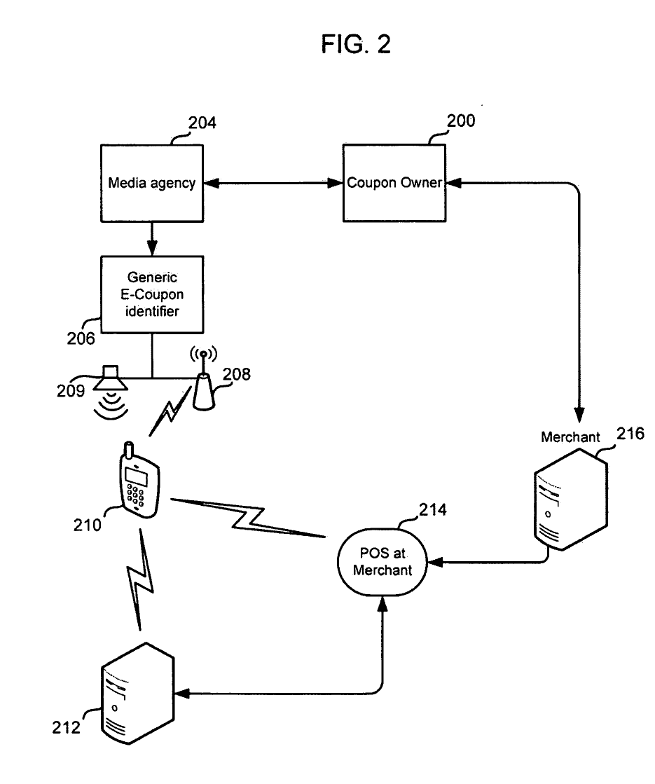

As the use of mobile devices has become widespread, they provide near-ubiquitous vehicles for distributing and redeeming E-Coupons. FIG. 2 illustrates an overview system of an exemplary embodiment in which a mobile device, such as a cellular telephone, is used to request, receive and redeem personalized E-Coupons. It should be noted that while this and other embodiments feature a mobile device receiving generic E-Coupons, and requesting and receiving redeemable E-Coupons, various steps may also be accomplished using immobile devices, such as desktop computers or kiosks, either alone or in combination with mobile devices.

In the system embodiment illustrated in FIG. 2, a coupon owner 200, which may be a manufacturer of merchandise or a commercial service provider, launches an E-Coupon program with a merchant 216. The coupon owner 200 may also contract with a media agency 204 to create and distribute personalized E-Coupons to consumers. Generic E-Coupon identifiers (IDs) 206 are created for each type of coupon to be issued and distributed to mobile devices 210 via one or more distribution media 208, 209. A generic E-Coupon ID 206 may be a symbol or data that indicates a particular type of coupon that can be received or an address to an E-Coupon Manager 212 that the mobile device 210 can contact to receive an E-Coupon, but not a specific coupon that can be redeemed. These distribution media 208, 209 may include traditional media channels, such as audio speakers 209, visual and video displays, telecommunication channels, multimedia channels, wireless data networks 208, Smart tags, or combinations thereof, as described more fully herein.

Upon receiving a generic E-Coupon ID 206, the mobile device 210 may request a personalized E-Coupon from the E-Coupon Manager 212 by forwarding the generic E-Coupon ID 206 or by using the generic E-Coupon ID 206 information to contact the E-Coupon Manager 212 in a particular manner. The E-Coupon Manager 212 may be a server including a processor and memory and configured to receive inquiries from mobile devices 210 and generate and store personalized E-Coupons in response to such inquiries. For example, a mobile device 210 may receive a generic E-Coupon ID 206 which includes an identifier of a particular product for which E-Coupons are available, an identifier of the source from which the mobile device 210 received the generic E-Coupon ID 206, some localization-specific, consumer-specific or device specific information that can be used to personalize the E-Coupon, and an address or other identifier of the E-Coupon Manager 212 that the mobile device 210 can use to request a redeemable coupon. As one specific example, the generic E-Coupon ID 206 may be an IP address or URL to a specific webpage (i.e., URL to webpage plus appended references to a particular html file) maintained on the E-Coupon Manager 212 server associated with a particular product E-Coupon and the location of the particular distribution source (e.g., a store identifier). Using such information, including the location of the source of the generic E-Coupon ID 206, the E-Coupon Manager 212 can generate a personalized E-Coupon. As another example, the generic E-Coupon ID 206 may include a product code, a merchant code and an E-Coupon Manager code that the mobile device 210 can use to look up the address of the E-Coupon Manager 212 (e.g., from memory or from a central website server having an IP address known to the mobile device 210). The mobile device 210 can then send the product code and merchant code to the E-Coupon Manager 212 to request a personalized E-Coupon that is personalized for the particular merchant (i.e., a personalized location specific E-Coupon).

Personalized E-Coupons may be in the form of a symbol or data that indicates a specific coupon of assigned value issued to a particular consumer that can be redeemed. Such personalized E-Coupons are sent to the mobile device 210 (or other computing device) by the E-Coupon Manager 212, and may be redeemed by presenting the mobile device 210 at the point-of-sale (POS) 214. The POS 214 may use various methods and systems to receive, retrieve or process personalized E-Coupon from the mobile device 210. For example, the POS 214 may use one or more of a variety of wireless communication technologies, including a near field communication (NFC) data link, a far field communication (FFC) data link (e.g., WiFi or BlueTooth® technologies), a visual data link such as bar code reader, or an infrared communication link. Alternatively or as a backup, the POS 214 may receive the E-Coupon by a clerk manually entering the E-Coupon identification code (which may be displayed on the mobile device 210 for this purpose) into a keypad on the POS 214 system. As a further embodiment, the E-Coupon may be also or alternatively printed out as a paper coupon from a nearby printer, such as the receipt printer of an automatic teller machine (ATM) (such printing could be an add service offered by some ATM providers) or a printer at a computer kiosk (such as computer kiosks like those currently provided by some merchants to allow consumers to look up and printout conventional coupons). Such printed versions of the E-Coupon may include the same coupon identification information as stored in the E-Coupon, and may encode such information in barcodes or other machine readable formats to facilitate processing the coupon at the point of sale.

In an embodiment, personalization of E-Coupons may involve a multi-step process. The process may include receiving the generic E-Coupon (including any information encoded in that information), information from the mobile device 210, and crafting an E-Coupon using the received information (e.g., source location, time, and information received from the mobile devise) that meets the coupon owner's marketing objectives. Information used in creating personalized E-Coupons may be received by the E-Coupon Manager 212 from a mobile device 210 may come in three sets. The E-Coupon Manager 212 may use all three sets of data to create personalized and customize E-Coupons for the user of the mobile device 210.

The first set of data will be information sufficient to identify the generic E-Coupon 206 and (optionally) information regarding how, when and were the generic E-Coupon 206 was delivered to the mobile device 210. As mentioned before, this information may be conveyed in the form of a unique identifier or URL associated with a particular product and location, a set of identifiers associated with products and locations, or any other scheme of information encoding that provides product, location and delivering information in a form useable by the E-Coupon Manager 212.

A second set of data may include information about the owner/user of the mobile device 210, such as information about the user's coupon redemption practices and/or purchase history. To respect privacy concerns, users may elect to enable the transmission of this information or to keep such information private (i.e., not shared with the E-Coupon Manager 212). Users may also elect to enable their mobile device 210 to provide some personal data, such as that may enable the E-Coupon Manager 212 to provide them with more valuable coupons by more closely matching their personal needs and interests. Examples of such shareable user information include, for example, age, sex, educational background, occupation, income bracket, purchasing preferences, hobbies, favorite sports teams, political party, etc.

A third set of data that may be communicated to the E-Coupon Manager 212 includes information and specifications regarding the mobile device 210 itself, such as its security level and capabilities, make and model, memory capabilities, display screen size, display capabilities, processor capabilities, communication capabilities (e.g., supported communication technologies) and loaded applications. Such device-specific data enables the E-Coupon Manager 212 to format coupons so they can be received, managed and processed by the user's mobile device 210.

Once a personalized E-Coupon is created, the E-Coupon Manager 212 makes it available to the consumers, such as by transmitting it to mobile device 210, such as using the same communication link used by the mobile device 210 to request the coupons. The mobile device 210 can then store the personalized E-Coupons until they are to be redeemed. To redeem an E-Coupon, a consumer purchases the associated goods or service and presents the mobile device 210 storing the E-Coupon to the POS 214. Information sufficient to identify the E-Coupon is transmitted to the POS 214 using any one or more of the communication links described above. The POS 214 and/or the merchant's enterprise server 216 may then communicate with the E-Coupon Manager 212 and/or the coupon owner 200 to report redemption and to receive reimbursement for the coupon value.

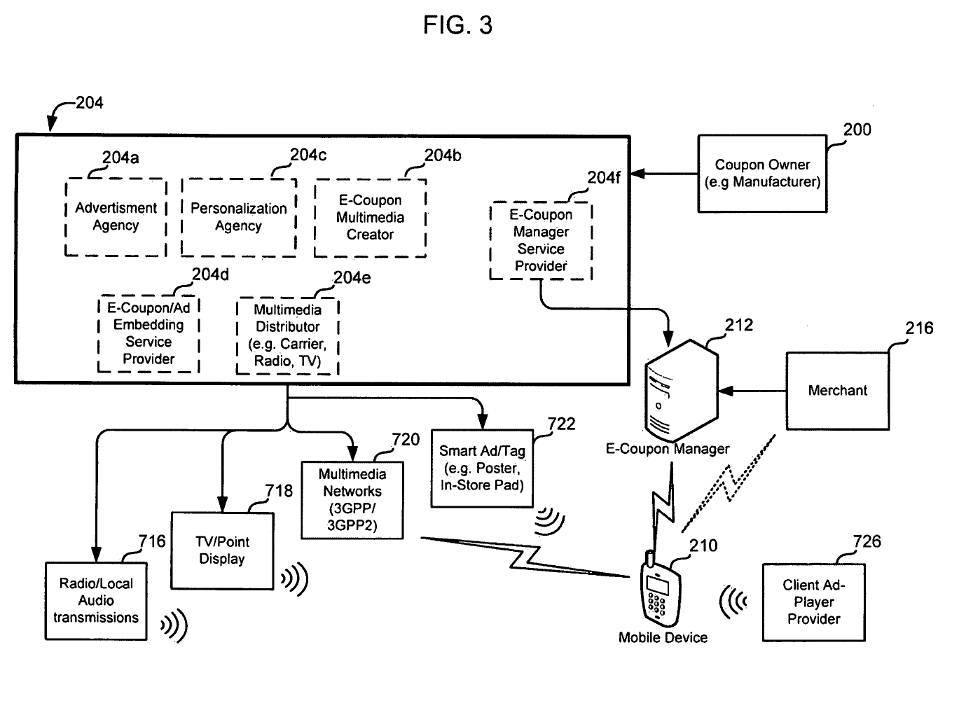

FIG. 3 provides more detailed system diagram for delivering personalized E-Coupons using a variety of distribution media. As discussed above, a owner 200, such as a manufacturer, service provider or retailer, launches an E-Coupon campaign to achieve some marketing objectives. To achieve these ends, the coupon owner 200 may contract with a media agency 204 to handle some or all of the tasks of creating, personalizing, distributing and managing E-Coupons. To perform such tasks, the media agency 204 may contract with other businesses. For example, the media agency 204 may contract with an advertisement agency 204a, an E-Coupon multimedia creator company 204b, a personalization agency 204c, an E-Coupon/add embedding service provider 204d, a multimedia distributor 204e (e.g., a radio or TV carrier), and an E-Coupon Manager service provider 204f. The tasks associated with each of these companies may also be done in-house at the media agency 204.

In creating the E-Coupon, the media agency 204 may collect information from merchants 216, the coupon owner 200 and the advertisement agency 204a. Merchants 216 may provide the locations in which the E-Coupons may be used, as well as technological capabilities of the POS systems. The coupon owner 200 may specify the amount of discount and the validation dates for the incentive, as well as marketing objectives and information about the concerned products or services. The advertisement agency 204a may provide marketing data and the overall design for the E-Coupon. An E-Coupon multimedia creator 204b may work in conjunction with the personalization agency 204c and the multimedia distributor service provider 204e to determine queries and technologies to be used in the E-Coupon campaign in order to obtain from mobile devices the type of consumer information needed to personalize and customize the E-Coupons to targeted individual consumers. For example, if the coupon owner 200 is a manufacture of computer games, the targeted consumer will be gamers (i.e., those who purchase and play games). The coupon owner 200 will task the media agency 204 (and or the other service providers) to craft E-Coupons that will be delivered only to gamers at times and locations most likely to motivate purchase. The media agency 204 (and or the other service providers) may be further tasked to craft E-Coupons that appeal to the personality of gamers, such as including customized animations, game trailers or even links to enable users to download or play a short version of a game associated with the E-Coupon. Of course, coupon owners 200 in other industries and with different customer demographics may task the media agency 204 to prepare very different personalized E-Coupons 200.

An E-Coupon/Ad embedding service provider 204d may provide the technology by which generic E-Coupon data may be embedded in and delivered by different distribution media 304. For example, an E-Coupon/Ad embedding service provider 204d may provide the digital watermarking technology to embed generic E-Coupon identifiers 206 into audio or video streams, into static displays, or within multimedia transmissions. The watermarked media streams or transmission may then be turned over to a multimedia distributor 204e which takes care of broadcasting the media at desired locations. For example, the multimedia distributor 204e may be a supplier of background music supplied to subscriber merchants, program distributors for national or local radio or television stations, cellular network carriers, or companies that provide audio and video services to shopping malls and merchants.

The media agency 204 may also host the E-Coupon Manager server 212 or contract with an E-Coupon Manager service provider 204f. An E-Coupon Manager service provider 204f may operate and manage the E-Coupon Manager 212 server. In addition to creating and delivering the personalized E-Coupons to consumers, the E-Coupon Manager 212 or the E-Coupon Manager service provider 204f may provide the coupon owner 200 with reports and statistics based on E-Coupons generated and redeemed, as well as stored user information. Such feedback from the generation and redemption of E-Coupons may be very useful to the coupon owner 200 as well as the media agency 204 in preparing future marketing, promotion and advertising campaigns.

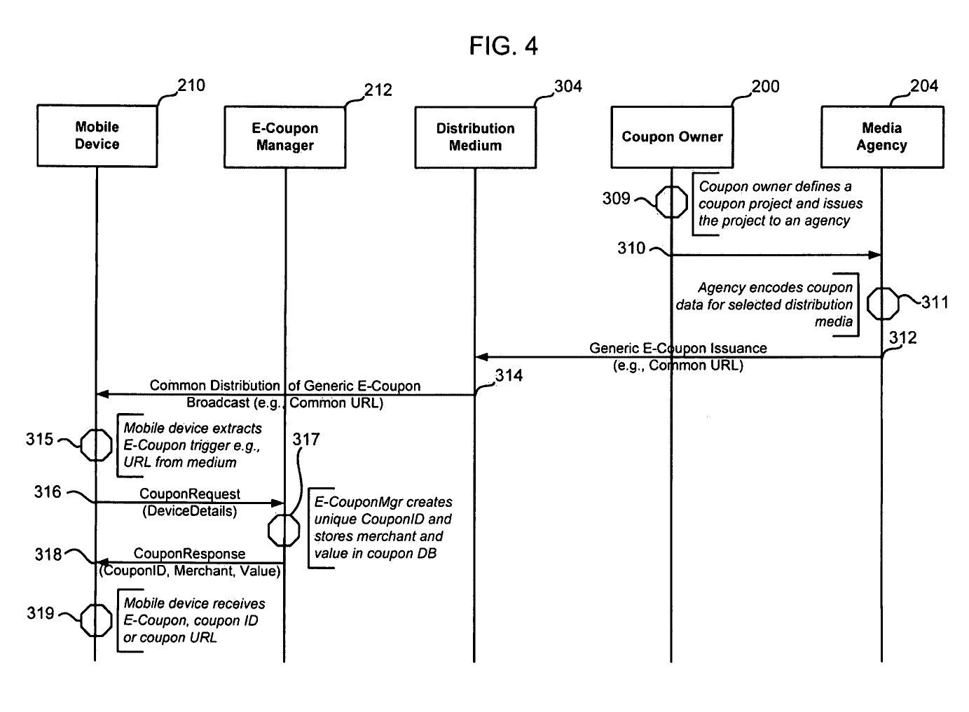

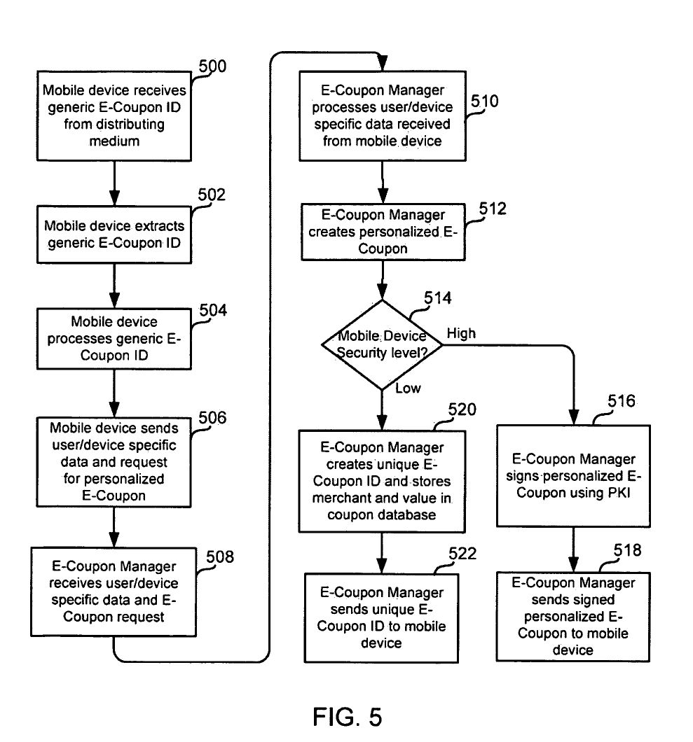

As discussed above, once a generic E-Coupon ID 206 is created, it may be embedded or encoded into one of a variety of distribution medium 304 for transmission to user's mobile devices 210. In an exemplary embodiment, the distributing medium may be audio 716 which is emitted by speakers within a merchant's facility. A generic E-Coupon ID 206 may be embedded into the audio transmission using digital watermark technology. The audio transmission 716 can be received by the microphone within mobile devices 210 located near the speakers. Audio transmissions 716 may allow for both broad and localized distribution of generic E-Coupons. For example, audio transmissions 716 broadcast by a radio station can target a large number of listeners, while watermarked background music playing within a store can target only the consumers in that store. Since consumers in a store of particular types of merchandise (e.g., pet supplies) are likely interested in the merchandise carried the particular store, E-Coupons related to such merchandise delivered in this manner can be targeted to consumers more likely to redeem the coupons than if the E-Coupons are delivered via a radio broadcast. For example, if a clothing store is playing watermarked background music, store customers may automatically receive a personalized E-Coupon for a T-Shirt that is on sale at that particular store at that particular time. To receive the E-Coupon, the microphone in the consumer's mobile device 210 receives audio which is processed by application software running on the device's processor to recognize and recover the generic E-Coupon ID 206 embedded in the watermark. More detailed discussion of methods for processing the generic E-Coupon ID 206, communicating with the E-Coupon Manager 212 and receiving a personalized E-Coupon using methods described in more detail below with reference to FIGS. 4-8.

Generic E-Coupon ID 206 may also be embedded in images in a static images (e.g., movie poster or advertising display, or other “point display”) and in video displays 718. Mobile devices 210 can retrieve the generic E-Coupon data embedded in an image or video display 718 using a camera available on the devices and software configured to enable the processor to examine a digital photograph of the image or display. In an exemplary embodiment, video transmission may be in form of streaming video that is presented on video displays or projected on the wall or ceiling within a merchant. To retrieve an E-Coupon, consumers need only aim the camera within their mobile device at the image or display and enable the device to search for coupons. Software operating on the device processors then detects the watermarked information, retrieves the generic E-Coupon data and requests a personalized E-Coupon using methods described in more detail below with reference to FIGS. 4-8.

Generic E-Coupon ID 206 may also be transmitted to mobile devices 210 via multimedia broadcasts via wireless networks like 3GPP (3rd Generation Partnership Project), 3GPP2, and other cellular or ad-hoc/local networks 720 that will soon be available to mobile devices. Such technologies, which will enable mobile device users to enjoy a wide range of media services, may also allow mobile devices to receive generic E-Coupons directly based upon their location, user settings, time of day and other factors. Since 3GPP/3GPP2 networks can determine mobile device locations (e.g., within cell zones and with the use of Global Position System (GPS) information provided by the mobile devices), the networks can be used to provide the same degree of specificity in delivering generic E-Coupons as perceptive (i.e., audio and video) communication methods. Further, the high bandwidth available using 3GPP/3GPP2 networks enables the delivery of more data to the mobile device, as well as the request for and delivery of personalized E-Coupons using the same networks. Methods for processing the genetic E-Coupon ID 206, communicating with the E-Coupon Manager 212 and receiving personalized E-Coupons generated by the E-Coupon Manager 212 are described in more detail below with reference to FIGS. 4-8.

Generic E-Coupons may also be delivered to mobile devices by near field communication and RFID communication links which enable the creation of Smart Ads. Methods for processing Smart Ads, communicating with the E-Coupon Manager 212 and receiving personalized E-Coupons generated by the E-Coupon Manager 212 are described in more detail below with reference to FIGS. 9-12.

Personalizing E-Coupons may increase the likelihood that a coupon will appeal to an individual consumer's purchasing practices and motivations, and thus increase the likelihood it will be redeemed. The degree of personalization may be increased by using more consumer specific information. By combining location, time, user purchase history, purchase behavior, and user demographic and personal preferences, the E-Coupons generated by the E-Coupon Manager 212 can be made extremely targeted. Accurate targeting of E-Coupons should help to increase the rate of response by consumers by giving them coupons for things they want at a place and time the coupon can be redeemed. Thus, it is expected that personalizing E-Coupons may prove to be effective and efficient means of advertising for coupon owners 200 and merchants 216.

The E-Coupon Manager 212 may personalize and customize E-Coupons based on pre-set determinations or criteria defined by the coupon owner 200 and/or the media agency 204. In an exemplary embodiment, in addition to location data which may be obtained from the generic E-Coupon ID, the mobile device 210 may provide the E-Coupon Manager 212 with information regarding user purchase behavior and/or E-Coupons that have been redeemed in the past. The E-Coupon Manager can use this additional information to increase the level of personalization of the E-Coupons for that particular individual. For example, when a consumer visits a local grocery store, the mobile device 210 may retrieve a generic E-Coupon ID 206 broadcasted through the store's background music, and communicate its location to the E-Coupon Manager 212 by requesting a redeemable coupon. The mobile device 210 may provide information on E-Coupons that the consumer has redeemed in the same grocery store. The E-Coupon Manager 212 can then return personalized E-Coupons relating to the groceries and products that the user habitually purchases, with those coupons arriving in the mobile device while the consumer is still browsing the store.

An embodiment illustrated in FIG. 4 shows how an E-Coupon is personalized and delivered to a consumer's mobile device 210 in a series of communications among the system participants illustrated in FIGS. 2 and 3. A coupon owner 200 defines a coupon project, step 309, and communicates the project to a media agency 204 for personalization and distribution of its consumer incentives, messages 310. In some implementations, the coupon owner 200 may initiate this process by sending an electronic message 310 to the media agency 204 including the particular merchandise or service covered, the coupon value and restrictions or requirements on redemption. The media agency 204 selects a distribution medium 304 for the generic E-Coupon, such as an audio transmission, step 311, and sends the information required to deliver generic E-Coupons to a distribution medium, messages 312. The transmission of the generic E-Coupon information to the distribution medium 304 may be in the form of a message 312 containing the generic E-Coupon information that is received and stored by a processor (e.g., a server) associated with the distribution medium. Alternatively, the transmission 312 may be a continuous stream of information to be broadcast over the distribution medium.

The distribution medium 304 broadcasts the generic E-Coupon through the distribution medium 304 to all addressable mobile devices 210 within range, messages 314. As described more fully above, the distribution medium 304 can be any one or more types of broadcast media that can be received by mobile devices 210, including sound (e.g., watermarked music or inaudible sound), light (e.g., images) and radiofrequency radiation (e.g., wireless network communications and RFID tag transmissions). For example, the media agency 204 may provide an audio stream (e.g., music or inaudible sound) to the distribution medium which comprises one or more speakers (e.g., a store audio system) that transmit the audio stream as sound. Thus, the destination of the generic E-Coupon information depends upon the type of broadcast media and the location of the broadcast. The generic E-Coupon information may be a URL or Internet IP address that the mobile device 210 can access via the Internet to obtain personalized E-Coupons.

A mobile device 210 receives the broadcast and extracts the encoded generic E-Coupon ID 206 including information needed to request a redeemable coupon, step 315. Using the generic E-Coupon information, the mobile device 210 can contact the E-Coupon Manager 212 and request personalized E-Coupons using an available communication link, message 316. Typically, the communication link used to request personalized E-Coupons will be a wireless data link, such as a NFC, WiFi, Bluetooth, or cellular data network, however, the communication link may also employ sound or light (e.g., an infrared data link) if a suitable transceiver is available at the point of reception. The E-Coupon Manager 212 uses data received from the mobile device 210 to create a personalized E-Coupon, step 317, which it transmits back to the mobile devices 210 by an available communication link, message 318. Again, the communication link will typically be a wireless data link, such as a NFC, WiFi, Bluetooth, or cellular data network, but other technology data links may be employed if available. Finally, the mobile device receives the personalized E-Coupon and stress the information in memory so that it can be recalled at a later time for redemption, step 319.

Where the mobile device 210 requests a personalized E-Coupon using the Internet (e.g., via a cellular network connection to the Internet), message 316, the open socket established with the E-Coupon Manager 212 server provides a convenient link for promptly returning the personalize E-Coupon, message 318. Since the IP link established to send the message 316 requesting a coupon may be encrypted (e.g., by requesting and negotiating an SSL connection to the server), as would be appropriate if the mobile device 210 is transmitting personal data, this secure connection can be used to send the personalized E-Coupon, message 318, so it is protected from interception or eavesdroppers. Of course, the message 318 transmitting the personalized E-Coupons may also be communicated to mobile devices 210 via other communication means, such as e-mail, short message service (SMS) message, or other datagram-based message exchange systems that may apply message-level encryption and/or integrity protection.

An example process for distributing personalized E-Coupons is illustrated in FIG. 5. As described above, a mobile device 210 may receive a generic E-Coupon ID 206 from a distribution medium, such as an audio transmission, step 500, and extract the generic E-Coupon ID 206 from the watermark, step 502. The mobile device 210 then processes the generic E-Coupon ID 206, step 504, and sends ID along with user and device specific data a request for a personalized E-Coupon to the E-Coupon Manager 212, step 506. The E-Coupon Manager 212 receives the E-Coupon ID and user and device specific data with the request for a personalized E-Coupon, step 508. The E-Coupon Manager 212 processes the received data, step 510, and creates a personalized E-Coupons for transmission to the mobile device 210, step 512. The E-Coupon Manager 212 then makes the personalized E-Coupon available to the mobile device 210, such as by transmitting the personalized E-Coupon to the mobile device 210 via a wireless communication link, step 518 or 522. This wireless communication link may be the established IP session initiated by the mobile device 210 to request the coupon in the first place.

The E-Coupon Manager 212 may configure and distribute the personalized E-Coupons to the consumer in a manner that depends on the security level capabilities of the requesting mobile devices 210, test 514. If a device fulfills the trust and/or security requirements of a specific E-Coupon issuer, then an E-Coupon may be provided which includes the E-Coupon's value and redemption information as well as digital signatures to confirm its authenticity. Such trust and security requirements may be implemented by providing the mobile device 210 with the ability to secure data using encryption and authenticate itself to the E-Coupon Manager 212 (i.e., test 514=“High”). If the mobile device 212 has such capabilities, the E-Coupon Manager 212 may electronically sign the personalized E-Coupon using a cryptographic or digital signature, such as a Public Key Infrastructure (PKI) digital signature for example, step 516, and send the signed personalized E-Coupon to the mobile device 210, step 518. If the security of the mobile device 210 is low, meaning it lacks an ability to secure data using encryption and authenticate itself to the E-Coupon Manager 212 (i.e., test 514=“Low”), the E-Coupon Manager 212 may not send the E-Coupon itself. Instead, the E-Coupon Manager 212 may create a unique E-Coupon ID and associate the product, redemption merchant(s) and value to the E-Coupon ID in its coupon database, step 520, and send only the unique E-Coupon ID to the mobile device 210, step 522.

Security levels of mobile devices 210 can be important considerations in crafting and delivering E-Coupons because coupons have monetary value similar to currency. As new model mobile devices 210 become payment-enabled for use in making transactions using contactless communication technologies (e.g., NFC links), mobile devices will be equipped with secured chip technologies. This is because payment-enabled mobile devices 210 typically include secured chip technology on which financial data can be safely stored. Storing financial information on a secured chip protects the data from copying, modifying or forgery. Thus, the E-Coupon Manager 212 may send a PKI signed version of a redeemable E-Coupon to a high security mobile devices with low risk that the E-Coupon will be compromised. High security mobile devices may use PKI technology to receive and verify digitally signed E-Coupons and transmit E-Coupons in a secure manner. PKI technology and its use in creating electronic signatures are well known in the art.

In contrast, low security mobile devices may be sent an E-Coupon ID that corresponds to an actual E-Coupon that the E-Coupon Manager 212 stores in a server database. At the point-of-sale 214, consumers can redeem such an E-Coupon by providing the E-Coupons ID (which may be stored on their mobile devices 210) to the POS or merchant enterprise system. Using the unique E-Coupon ID the POS or merchant enterprise system can retrieve sufficient information regarding the E-Coupon from the E-Coupon Manager 212 server database to complete redemption processing.

Instead of directly transmitting the personalized E-Coupon to the mobile device 210, in an embodiment the E-Coupon Manager 212 may send a message that informs the mobile device 210 (or other computer) that a coupon is available for download. For example, the E-Coupon Manager 212 may transmit a URL to the mobile device 210 that it can use to access and download the personalized coupon from a server maintained by the E-Coupon Manager 212. Notification of the availability of a personalize E-Coupon for download can be communicated to the mobile device 210 by synchronous communication links (e.g., via the established communication link with the E-Coupon Manager 212 or the distribution medium that delivered the generic E-Coupon) or asynchronous communication links (e.g., e-mail or SMS message). Once notified, the mobile device 210 can establish a communication link to download the personalized E-Coupon from the identified source (e.g., URL) automatically or upon user actions. The coupon availability notification message may include a date and/or time when the coupon can be download. This embodiment may be advantageous in a number of situations. For example, in situations where communication links with mobile devices 210 are unreliable, mobile devices 210 can establish a link to the identified download source whenever communication conditions improve (e.g., the user moves outside or within a cellular network coverage area). As another example, coupon owners may be interested in issuing personalized E-Coupons that will be delivered and available at a later time, such as to entice a consumer to revisit a store at which the generic E-Coupon was delivered. As a further example, coupon owners may wish to distribute generic E-Coupons to one device, such as mobile devices 210, and distribute personalized E-Coupons to another device, such as a personal computer connected to the Internet. Further example embodiments for distributing personalized E-Coupons include delivering the E-Coupon by text messaging (e.g., SMS, MMS, EMS, etc.) or electronic mail, or by tapping an NFC-enabled mobile device to an NFC-enabled kiosk, personal computer or point of sale terminal.

An example of a data packet that may be used for communicating a generic E-Coupon ID 206 using any of the various communication methods is illustrated in FIG. 6A. In order to inform mobile devices 210 that a generic E-Coupon is about to be transmitted, a data packet may begin with an attention (ATTN) Symbol 400a (or other similar symbol). The ATTN Symbol 400a informs mobile devices 210 that a message packet is about to start and may include a synchronization pattern sufficient to allow the receiving mobile device 210 to recognize and decipher the message packet. In this manner, generic E-Coupons may be transmitted without the need to have a communication link already established between mobile devices 210 and the distribution medium 304.

Following the ATTN Symbol 400a may be an E-Coupon message symbol 400b which is a unique code or symbol that the mobile device 210 can recognize that the incoming message is related to an E-Coupon. Including an E-Coupon message symbol 400b in the message structure enables the various embodiments to be employed for other communications with consumers. Mobile devices 210 can recognize the E-Coupon message symbol 400b to distinguish the message packet from other types of communications, and prepare to handle the message packet payload accordingly. For example, the same basic message structure may be used to communicate both generic E-Coupons and personalized E-Coupons, as well as other information (e.g., announcements, advertisements, etc.) with the type of coupon distinguished by the E-Coupon message symbol 400b.

The body or payload of the message packet may include an E-Coupon ID 400c that the mobile device 210 can extract, store and act upon. Depending upon the implementation or the type of coupon (e.g., indicated by the E-Coupon message symbol 400b), the receiving mobile device 210 may format and transmit personalized data along with a request for an E-Coupon to E-Coupon Manager 212 using information contained in the coupon identifier 400c. For example, the coupon identifier 400c may include a URL address that the mobile device 210 can use to establish an Internet session (e.g., via a WiFi or cellular data network connection) with the E-Coupon Manager 212. As is well known in the Internet arts, the URL may include within the address string identifying information, similar to a session ID, that the E-Coupon Manager 212 can use to determine the specific type and issuer of the E-Coupon, as well as information regarding the type and location of the broadcast medium. As another example, the coupon identifier may include a code or symbol that mobile devices 210 must return to the E-Coupon Manager 212 in a request for personalized E-Coupons. Such coupon identifier information may then be used by the E-Coupon Manager 212 to determine the E-Coupon to be issued and the consumer's location based on the particular distribution medium that delivered the generic E-Coupon.

In order to enable mobile devices 210 to verify that a message packet has been accurately received well known forward error correcting (FEC) coding methods may be employed, such as including a parity bit or other FEC code 400d within the message. Generic E-Coupons may be distributed over noisy and unreliable data transmission media, such as watermarked background music played over multiple speakers in a noisy environment. In such situations the bit error rate in such transmissions may be very high due to interference and noise. By repeatedly transmitting the same data packet with sufficient FEC or error detecting codes, a mobile device 210 can continue to receive message packets until it determines that a packet has been accurately received. Finally, the message packet may conclude with an end symbol 400e to inform mobile devices 210 that the message packet has ended. Including an End Symbol 400e enables mobile devices 210 to distinguish between message packets that may be transmitting continuously. Including an End Symbol 400e also allows message packets to be of different sizes, such as to support other communications and different structures of generic E-Coupons.

Personalized E-Coupons sent from the E-Coupon Manager 212 to mobile devices 210 (or other computers) may include several data components to enable their distribution, management and redemption. FIG. 6B illustrates an example message structure suitable for transmitting a personalized E-Coupon message 600 from an E-Coupon Manager 212 to a mobile device 210. The E-Coupon message 600 may include a Coupon Type 600a field to indicate the value or product associated with the E-Coupon. An E-Coupon Source ID 600b may also be included to indicate the coupon owner or the E-Coupon Manager 212. If the E-Coupon message 600 is sent to a low security mobile device, the message may include an E-Coupon ID field 600c. The unique E-Coupon ID stored in the E-Coupon ID field 600c can be used at the point-of-sale to enable the POS or merchant enterprise system to contact and retrieve the corresponding E-Coupon information from the E-Coupon Manager 212. The unique E-Coupon ID may be created from a sufficiently large number space to ensure uniqueness among all products/services and coupon owners. Optionally, the personalized E-Coupon message 600 may include a brief description of E-Coupon 600e which may be used by the receiving mobile device 210 to categorize and manage the E-Coupon, as well as generate a display to inform the consumer of basic information regarding a received E-Coupon. The E-Coupon message 600 may also include graphics, advertising text, animation, sound and or other multimedia data 600d that may be used to generate a customized display of the E-Coupon on the mobile device 210.

Mobile devices 210 may be configured to receive, process and store personalized E-Coupons that are sent by the E-Coupon Manager. Mobile devices 210 may also be configured to alert the user upon receipt of an E-Coupon. E-Coupons may be stored in a mobile device 210 for future redemption. Users may access the stored E-Coupons for redemption or to review the coupons they have received. E-Coupons received by the mobile device may be stored chronologically, alphabetically or in any other order.

FIG. 7 shows an exemplary data structure that mobile devices may use to store E-Coupons in memory. Organizing E-Coupons in a data structure facilitates reviewing and redeeming E-Coupons, as well as maintaining a history of redeemed E-Coupons. E-Coupon data may be organized in a data table 700 comprising data records 701a-701c for each E-Coupon, with each data record including a variety of data fields 702a-702h to store the E-Coupon details. For example, E-Coupon data records 701a-701c may include data fields for storing the unique E-Coupon ID column 702a, a description of the E-Coupon 702b, the coupon source or owner 702c, redemption sites (i.e., where the consumer can go to redeem the coupon) 702d, the coupon's value 702e, the coupon's validity period (i.e. earliest time of use and expiration date) 702f, a field to record whether the E-Coupon has been redeemed 702g, and a field to record whether the E-Coupon redemption has been confirmed 702h.

For example, if the E-Coupon is for a discount on movie tickets, then the coupon's data record 701a may include a description of the column 702b include the phrase “Movie ticket discount.” Such a description can be used to inform the consumer what the coupon is for. In this example, the coupon was issued by AMC and is redeemable in any AMC theater for a $3.00 discount prior to Apr. 1, 2009. Also, the consumer has already redeemed the E-Coupon as indicated by the “Y” (which may be stored as a digital “1”) stored in data field 702g, and the transaction was completed and the redemption confirmed as indicated by the “Y” stored in data field 702h. If the coupon had not been redeemed or if redeemed had been confirmed, then a “N” would be stored in data fields 702g or 702h as shown, for example, in data records 701b and 701c. The coupon expiration and status data fields 702f, 702g, 702h may be used by the mobile device 210 or the user to identify personalized E-Coupons which may be deleted from memory, such as those coupons which have expired, or been redeemed and confirmed. Similarly, these data fields may be used by the mobile device 210 to identify redeemed coupons which were never confirmed, and therefore may be reset as available for redemption (such as by setting the “cashed” data field to “N”).

Other data fields may be included in a E-Coupon data table. For example, data fields may be included for storing graphic and text data provided with the E-Coupon that may be used to generate a customized presentation of the coupon on the mobile device's display. Also, more data fields may be included to store the date that coupons are received and redeemed.

As will be appreciated by those of skill in the art, the entries shown in the data structure in FIG. 7 are illustrative only, since in most cases the information stored in such data structures will be digital and in the form of digital codes (i.e., patterns of 1's and 0's) or flags (i.e., “1” or “0”). Mobile devices 210 may be configured by software instructions to interpret the digital information and present the information to users in a format people can understand.

Using E-Coupon information stored in memory (e.g., in a data structure illustrated in FIG. 7), the mobile device 210 may be configured with a software application, such as an Ad-player, to allow users to view advertisements and E-Coupons on the mobile device. Such an ad-player application may present the E-Coupon in the form of a thumb-nail view of the E-Coupon on the mobile device display. In mobile devices 210 which are able to use wireless data networks, the Ad-player application may be a client application that may allow the user to receive E-Coupons and simultaneously access the merchant's website to view advertisements and purchase the product and redeem the E-Coupon immediately.

FIG. 8 shows an overall process flow diagram embodiment for distributing personalized E-Coupons using a variety of transmission media. A coupon owner or a media agency may create a generic E-Coupon ID, step 800, and embedded it into an audio transmission 716 using digital watermark technology, step 801. The audio transmission containing the embedded watermark is then broadcasted, such as being distributed to stores where the audio is played on speakers, step 802. Depending on the settings of the mobile device 210, the device may automatically search for E-Coupons, step 806, or search for E-Coupons when a user manually directs the mobile device to search for E-Coupons, step 808. If the mobile device 210 is set to automatically search and detect E-Coupons, step 806, the mobile device 210 receives the generic E-Coupon ID 206 in the audio transmission 716. If the mobile device 210 is not set to automatically search for E-Coupons, then the user may manually activate the mobile device 210 to received embedded generic E-Coupon identifiers 206 from audio transmission 716, step 808. As a third option, the mobile device 210 may be configured with software instructions to automatically search and detect E-Coupons when it determines that it is currently in certain locations, i.e., its position satisfy location parameters for initiating the search and detect function. Mobile devices 210 may determine their location using a variety of technologies, including GPS receivers for example. Such location-triggered search and detect functions may be configured by users based on locations known to them to issue E-Coupons, may be provided to mobile devices 210 over the air (such as by service providers), or may be based upon other criteria, such as the location of major shopping centers (e.g., malls and large department stores) where E-Coupons sources are likely to be positioned. This third option functions similar to the automatic search an detect process step 806 shown in FIG. 8. Once the mobile device 210 has received the audio transmission 716 with embedded generic E-Coupon ID 206, the method proceeds as described above with reference to FIG. 5 for steps 500-522.

If the generic E-Coupon identifiers 206 is embedded in a static or video image, step 900, the watermarked image may be displayed, step 904, or the video may be broadcasted, step 902, and then displayed on a monitor, step 904. If the generic E-Coupon is embedded within a video transmitter, it may be received directly by a video transmission receivers and other associated hardware and software within the mobile device 210, either automatically, step 806, or in response to a user activation, step 808. If the generic E-Coupon is embedded in a watermarked static image or video image presented on a monitor, step 904, a user must point the camera on the mobile device at the image to receive the generic E-Coupon, step 906. The mobile device can then analyze the received image to extract the generic E-Coupon. Once the mobile device 210 has received the audio transmission 716 with embedded generic E-Coupon ID 206, the method proceeds as described above with reference to FIG. 5 for steps 500-522.

If the generic E-Coupon identifier 206 is embedded into a multimedia wireless network transmission 720 capable of addressing the mobile device 210, step 1000, such as data cast, multicast, broadcast networks, WiFi, WiMax and other wireless area networks, and CDMA, GSM, 3GPP or 3GPP2 cellular networks, it can be received directly by the appropriate transceiver hardware and software within the mobile device 210, either automatically, step 806, or in response to a user activation, step 808. In an embodiment, the mobile device 210 may turn on and monitor a 3GPP or 3GPP2 network for generic E-Coupons in response to receiving a signal from a broadcast media (e.g., watermarked audio or video as described above) or a narrow cast media (e.g., an RFID as described below with reference to FIG. 9). Once the mobile device 210 has received the audio transmission 716 with embedded generic E-Coupon ID 206, the method proceeds as described above with reference to FIG. 5 for steps 500-522.

The various embodiments enable the creation and use of Smart Ads based upon RFID and other smart tags used to deliver generic E-Coupons. Smart Ads 722 may use radio-frequency identification (RFID) technology to deliver the generic E-Coupon as the data stored in an RFID tag that is automatically transmitted to an RFID interrogating transceiver. An RFID tag containing a generic E-Coupon can be applied to or incorporated into a product, product display, or fixed advertisement (e.g., a poster). When an RFID tag is placed on an advertisement, from the information transmitted by the RFID tag to a mobile device 210 to enable delivery of personalized E-Coupons can transform a simple poster into a Smart Ad 722. Similarly, RFID tags included within products and product packaging can transform the merchandise itself into a Smart Ad 722. Smart ads 722 may also be made using other wireless transmitters, such as WiFi and NFC transceivers.

In an exemplary embodiment, mobile devices 210 can detect the signals transmitted by RFID tags and then request redeemable E-Coupons associated with those tags from an E-Coupon Manager 212. For example, an RFID tag associated with a poster ad can communicate a generic E-Coupon ID to a consumer's mobile device when the consumer walks by or stands near the ad. Further, the RFID tag may be configured (e.g., with a timing routine, either in the RFID tag circuitry) to transmit the generic E-Coupon only if the consumer pauses to consider the poster ad. The consumer's mobile device 210 promptly requests a redeemable personalized E-Coupon from an E-Coupon Manager 212 associated with the generic E-Coupon. Then, while the consumer is still perusing the poster ad, a personalized E-Coupon is received on the mobile device with the coupon personalized to the consumer's location in front of the poster or to some consumer-specific information provided in the coupon request message. Thus, the consumer is presented with both the poster ad and a personalized coupon incentive to try the product or service simultaneously. Meanwhile, other consumers who cannot view the poster ad or who have not stopped to review it do not receive coupons. In this manner, coupon owners (and their advertising agencies) ensure coupons are only delivered to consumers who see the ad and spend time reviewing it. Thus, a standard poster ad is transformed into an element of a system for actively targeting those consumers most likely interested in the coupon owner's products or services.

An example embodiment of processes associated with Smart Ads 722 are described below with reference to FIGS. 9, 10, 11 and 12. Referring to FIG. 9, Smart Ads may be enabled by sending and receiving a number of wireless transmissions among system participant. When a mobile device 210 comes within the signaling range of a Smarts Ad 722 transmitter (e.g., an RFID tag), an RFID interrogator transceiver within the mobile device 210 sends an RFID interrogation message 1106. In response to receiving the interrogation message, 1106, the RFID in the Smart Ad 722 transmits a generic E-Coupon signal, message 1108.

In an embodiment, the mobile device 210 may respond to receiving the RFID message 1108 by scanning other transmission channels from different broadcasting sources. For example, the mobile device 210 may query a 3GPP network 720, message 1110, for generic E-Coupon identifiers 206 relating to the merchandise or service addressed in the Smart Ad. In response to the query, the 3GPP network 720 may transmit a generic E-Coupon ID 206 to the mobile device 210, message 1112.

Whether the mobile device 210 receives a generic E-Coupon from the Smart Ad message 1108, or from other transmission channels, message 1112, the mobile device 210 sends a request for a personalized E-Coupon to an E-Coupon Manager 212, message 1114. As part of this request, the mobile device 210 communicates information from the generic E-Coupon and may also communicate user and device data with the E-Coupon Manager 212. The E-Coupon Manager 212 creates a personalized E-Coupon based on the received data, and transmits the personalized E-Coupon to the mobile device 210, message 1116.

The Smart Ad 722 transmission may be a unique merchandise ID message packet 1200 such as illustrated in FIG. 10. A Smart Ad may transmit a unique merchandise ID message packet 1200 that relates to specific merchandise (as when an RFID is integrated into a product or its packaging) or is unique to the advertisement (e.g., identifying the particular poster ad). The merchandise ID message packet 1200 may begin with an attention (ATTN) Symbol 1200a to enable the mobile device 210 to recognize and accept the message. Next, the message packet may include a unique merchandise identifier 1200b which uniquely identifies the merchandise or Smart Ad, and may include information to enable the mobile device to request a redeemable E-Coupon. The message packet may end with a well known FEC code or error detection code 1200c, such as a parity Bit, to enable the mobile device to detect or correct a transmission error, and an End Symbol 1200d to inform the mobile device that the message packet is ended.

A Smart Ad may also provide more information in the generic E-Coupon if the Smart Ad uses an RFID (for example) programmed with more information, or relies on another communication with another transmission channel (e.g., a 3GPP or 3GPP2 network). For example, as illustrated in FIG. 11, the generic E-Coupon ID 206 may include in its payload a unique merchandise identifier 1200b in addition to the information fields described above with reference to FIG. 6A. The components of the generic E-Coupon ID 206 are similar to those described above with reference to FIG. 6A for like numbered data fields. Including a unique merchandise identifier 1200b in the generic E-Coupon ID 206 can enable the E-Coupon Manager 212 to better structure a personalized E-Coupon in response to the Smart Ad.

An example process for implementing Smart Ads is illustrated in FIG. 12. A Smart Ad may include an RFID configured to transmit a unique merchandise ID 1200 signal that includes a unique merchandise identifier 1200b. Depending on its settings, the mobile device 210 may actively and automatically transmit RFID query signals, step 1204, or transmit RFID query signals in response to a user command, step 1206. The RFID tag within the Smart Ad responds to the query by transmitting a merchandise ID or generic E-Coupon ID, step 1208. This message is received by the mobile device 210, step 1210. If the Smart Ad transmitted a generic E-Coupon ID, the mobile device may proceed to request a redeemable personalized E-Coupon as described above with reference to FIG. 5 proceeding with steps 500-522. On the other hand, if the Smart Ad provided a merchandise ID that is not a generic E-Coupon ID, the mobile device may request a corresponding generic E-Coupon from another network, such as any wireless network capable of addressing the mobile device 210, step 1212. The mobile device may provide the merchandise ID to the other network, which may then transmit to the mobile device 210 a corresponding generic E-Coupon, step 1214. Upon receiving this generic E-Coupon, the mobile device may proceed to request a redeemable E-Coupon including providing sufficient location, personal or device information to enable the generation and delivery of a personalized E-Coupon, as described above with reference to FIG. 5 proceeding with steps 500-522.

In an embodiment, a conventional RFID tag associated with merchandise (e.g., integrated in or on the merchandise) may be queried by an mobile device 210 to receive a unique merchandise ID. In this embodiment, the merchandise ID received from the RFID tag can be the same unique ID used by POS and merchant enterprise systems to track, inventory and secure merchandise, and need not be a configured as a generic E-Coupon. Upon receiving the merchandise ID, the mobile device 210 can search for generic E-Coupons or redeemable personalized E-Coupons previously received by the mobile device and stored in memory. In this embodiment, generic E-Coupons may include a merchandise IDs that can be stored. If the merchandise ID matches a redeemable personalized E-Coupon stored in the mobile device 210 an application can notify the user with a display and prepare the redeemable personalized E-Coupon for use. In this manner, the user is informed that the mobile holds a personalized E-Coupon for the scanned merchandise.

If the merchandise ID matches a generic E-Coupon but not a redeemable E-Coupon, the mobile device 210 may submit a request for a redeemable E-Coupon corresponding to the matched generic E-Coupon using the embodiments described herein. In this manner, the mobile device 210 only retrieves a redeemable E-Coupon when the user scans corresponding merchandise. This embodiment allows consumers to obtain E-Coupons for products they are planning to purchase.

In a further embodiment, if no generic or redeemable E-Coupon matches stored in the mobile device 210, the mobile device can contact a server which can dispense generic E-Coupons or another communication network, such as a 3GPP or 3GPP2 network, to request a generic E-Coupon associated with the merchandise ID. Such a coupon server or networks can then transmit to the mobile device any matching generic E-Coupons. Once received, the mobile device 210 can request a personalized redeemable E-Coupon according to the various embodiments. This embodiment allows consumers to obtain any available E-Coupons for products they are planning to purchase without the need to deliver generic E-Coupons first. This embodiment also allows coupon owners to personalize any E-Coupons issued as well as obtain valuable marketing information about consumers, since the request for a redeemable coupon may include information about the consumer.

Once the mobile device 210 has received a personalized E-Coupon from the E-Coupon Manager 212, the consumer may use that E-Coupon to receive discounts on purchases. An example system for redeeming personalized E-Coupons is illustrated in FIG. 13. A mobile device 210 carries redeemable E-Coupons in its memory that can be redeemed at a point of sale. The point of sale may include two terminals: a payment terminal 214 and a coupon redemption terminal 1304. In some instances these terminals may be combined into a single POS terminal. The coupon redemption terminal 1304 is equipped to receive E-Coupons from the mobile device 210.

The coupon redemption terminal 1304 may employ several types of technology for redeeming E-Coupons. For example, an E-Coupon may be redeemed using a Coupon redemption terminal 1304 may be equipped with either near field communication (NFC), infrared, visual (e.g., bar code reader) or far field wireless communication (FFC) transceivers. NFC is a short-range high frequency wireless communication technology which enables the exchange of data between devices over about a decimeter distance. The technology is a simple extension of the ISO 14443 proximity-card standard (contactless card, RFID) that combines the interface of a smartcard and a reader into a single device. An NFC device can communicate with both existing ISO 14443 smartcards and readers, as well as with other NFC devices, and is thereby compatible with existing contactless infrastructure already in use for public transportation and payment. To redeem an E-Coupon at a coupon redemption terminal 1304 (CRT) equipped with an NFC transceiver, the consumer merely brings the mobile device in close proximity to the terminal, communication links and data exchange then happen automatically.

The coupon redemption terminal 1304 may also be electronically coupled (e.g., via the Internet) to the E-Coupon Manager 212 and/or a coupon redemption technology provider 1310 to support the processing and retrieval of E-Coupons. The coupon redemption technology provider 1310 supplies technology that merchants 216 can use to retrieve and process E-Coupons, and may provide the link to the E-Coupon Manger 212. The payment terminal 214 is in communication with the coupon redemption terminal 1304 (such as to receive the discount information) and with a payment clearinghouse and a bank. The payment terminal also reports the value of the discounts associated with the E-Coupons to a clearinghouse 218. The clearinghouse 218 receives the information and generates statistical reports for the coupon owner 200. The merchant 214 is then either paid by the clearinghouse 218 or by the coupon owner 200.

An example embodiment of the processing steps and messages exchanged during E-Coupon redemption are illustrated in FIGS. 14 and 15 which are discussed together. A mobile device may receive a generic E-Coupon according to processes described in more detail above with reference to FIGS. 2-8, step 315 in FIG. 14. In response the mobile device 210 sends a request for a redeemable coupon to the E-Coupon Manager 212, message 316. The E-Coupon Manager 212 creates a personalized E-Coupon, step 317, and transmits it to the mobile device 210, message 318, where it is received and stored, step 1500 in FIG. 15. If the mobile device 210 is a device with low security levels, the E-Coupon will be stored on E-Coupon Manager 212 and a unique E-Coupon ID will be sent to the mobile device 210. If the mobile device 210 is a device with high security levels, a PKI signed E-Coupon with all the coupon information needed to redeem the E-Coupon is sent to and stored on the mobile device 210.

The user may visit a business, such as a merchant 216, in order to purchase the merchandise or services covered by an E-Coupon. At a merchant 216 the user may select desired merchandise, step 1502, and use a payment instrument, such as cash or a credit card, to pay for the merchandise at the payment terminal 214, step 1504. In some implementations, the consumer may receive the personalized E-Coupon, step 1500, as part of the process of selecting merchandise, step 1502, such as when a Smart Ad is included with the merchandise. At the time of payment the consumer may redeem a personalized E-Coupon to receive a discount by bringing the consumer's mobile device 210 within communication range of the coupon redemption terminal 1304, step 1506. The coupon redemption terminal 1304 and the mobile device 210 exchange NFC handshake messages, and when the NFC link is established, the mobile device 210 transmits E-Coupon information to the coupon redemption terminal 1304, messages 1312, step 1508. The coupon redemption terminal 1304 may test the E-Coupon information to determine if the coupon is PKI signed, step 1510. Alternatively, the mobile device 210 may inform the coupon redemption terminal 1304 of whether the mobile device is security enabled. The manner in which the E-Coupon is processed depends upon whether the coupon is authenticated using a cryptographic or digital signature.

If the E-Coupon is not signed (i.e., test 1510=“No”), as will be the case if the mobile device 210 lacks security capabilities, the E-Coupon information is an identifier linked to the E-Coupon data in a database maintained by the E-Coupon Manager 212. To retrieve the E-Coupon data for processing, the coupon redemption terminal 1304 (CRT) transmits the E-Coupon ID to the E-Coupon Manger 212; step 1514, message 1414. The E-Coupon Manager 212 receives the E-Coupon ID, step 1516, and uses the ID to search its coupon database, step 1518. In this search the E-Coupon Manager 212 determines the E-coupon's validity status, including whether the ID corresponds to an issued coupon and whether the coupon has already been redeemed, test 1520. If the E-Coupon ID doesn't correspond to an issued coupon or has already been redeemed (i.e., test 1520=“No”) the E-Coupon Manager 212 informs the coupon redemption terminal 1304 that the E-Coupon is invalid; message 1416, step 1522.

If the E-Coupon ID corresponds to an issued coupon that has not been redeemed (i.e., test 1520=“Yes”) the E-Coupon Manager 212 transmits corresponding E-Coupon data to the coupon redemption terminal 1304 for processing; message 1416, step 1524. The corresponding E-Coupon data may include information about the discounted merchandise, expiration dates, coupon value, applicable stores, and generally any other information that the merchant requires for processing the E-Coupon. The E-Coupon Manager 212 will then record in its data base that the E-Coupon has been redeemed and is no longer valid, step 1526. As part of recording this use status, the E-Coupon Manager 212 may record information regarding the E-Coupon, its redemption (e.g., where and when redeemed) and consumer information received from the mobile device 210 that may have been transmitted along with E-Coupon ID. The E-Coupon Manager 212 may also start a transaction timer, step 1528.

Upon receiving the E-Coupon data, the coupon redemption terminal 1304 provides the discount information to the payment terminal 214. The payment terminal 214 may be involved in a separate process submitting the consumer's payment vehicle (e.g., a credit card) for transaction approval. If the transaction payment is accepted, test 1530, the payment terminal 214 applies the coupon discount to the consumer's purchase, step 1532, and communicates the applied discount value to a coupon clearinghouse 218, message 1418. The clearinghouse 218 then provides the merchant 216 with a debit status, message 1320, and later reimburses the merchant 216 for the discount given to the consumer. Finally, the payment terminal 214 may inform the coupon redemption terminal 1304 that the transaction was accepted and the discount applied so the coupon redemption terminal 1304 can inform the mobile device 210 and E-Coupon Manager 212, step 1534. Notified that the transaction was accepted and the coupon discount applied, the mobile device 210 may store the redemption status in the corresponding E-Coupon data record. Similarly, the E-Coupon Manager 212 receives the notification, stops the transaction timer and stores the transaction completion status in the coupon database.

Occasionally, however, the payment transaction may encounter problems and the payment may not be accepted. For example, the credit card payment may be rejected by the issuing bank for not having sufficient credit. To address such cases, the coupon redemption terminal 1304 can be configured to automatically send a request to the E-Coupon Manager 212 to restore the E-Coupon. Thus, if the payment is not accepted (i.e., test 1530=“No”), the coupon redemption terminal 1304 may send a message to the E-Coupon Manager 212 requesting that the E-Coupon be restored; step 1536, message 1322. Upon receiving the request to restore an E-Coupon, step 1536, the E-Coupon Manager changes the status recorded in the database for the corresponding E-Coupon, changing its status from “redeemed” to “valid,” for example, step 1538. The coupon redemption terminal 1304 may also send a message to the mobile device 212 updating the E-Coupon records stored on the mobile device; message 1324, step 1540. Upon receiving the E-Coupon status update, the mobile device 210 may update the coupon's status field in the E-Coupon's data record stored in the device's memory, step 1542.

If the coupon redemption terminal 1304 fails to notify the E-Coupon Manager 212 of a completed transaction (step 1534) within a predetermined period of time following initiation of the transaction timer (step 1528), this may indicate that the transaction was cancelled or that some system failure (e.g., a communication or power failure) has occurred. This leaves the E-Coupon Manager 212 uninformed of whether the E-Coupon was actually redeemed. Therefore, if the transaction timer expires (i.e., time exceeds the predetermined period of time), step 1423, the E-Coupon Manager 212 may record this fact in the coupon database so it can manage the coupon according to a set of rules configured to address possible scenarios. For example, if a coupon clearinghouse or coupon owner later reports the E-Coupon has been redeemed, the E-Coupon Manager 212 can determine that the transaction must have been completed and change the status in the coupon database to redeemed. If the same E-Coupon ID is submitted by the same coupon redemption terminal 1304 within a short period of time, such as within an hour or a day, the E-Coupon Manager 212 may validate the coupon ID (step 1526) as if the prior request had not been made on the assumption (built into the processing rules) that there must have been a communication or power failure and the redemption is merely an attempt to complete the same transaction after the failure was resolved. If no further communication is received regarding the E-Coupon ID following a predetermined amount of time (e.g., a number of weeks), the E-Coupon Manager 212 may restore the E-Coupon's status to valid (step 1538) on the assumption (built into the processing rules) that the transaction was never completed. When the E-Coupon Manager 212 restores an E-Coupon to valid status after an unsuccessful redemption attempt, the E-Coupon Manager may also send a message to the mobile device 210 through an available communication link notifying the device of the coupon's revised status, message 1424.

If the E-Coupon received from the mobile device is PKI signed (i.e., test 1520=“Yes”), indicating that the mobile device has the capability to secure the E-Coupon data, the coupon redemption terminal 1304 can treat the received information as a redeemable E-Coupon and pass the discount (and optionally other data) information to the payment terminal 214, step 1512. In this situation, the E-Coupon stored on the mobile device 210 includes all the information required to apply the discount to the purchase transaction, so the coupon redemption terminal 1304 informs the payment terminal 214 of the discount to be applied. If the consumer's payment instrument is accepted (i.e., test 1530=“Yes”), the payment terminal 214 applies the coupon discount to the consumer's purchase, step 1532, and communicates the applied discount value and E-Coupon ID to a coupon clearinghouse 218, message 1418. The clearinghouse 218 then provides the merchant 216 with a debit status, message 1320, and later reimburses the merchant 216 for the discount given to the consumer. Finally, the payment terminal 214 may inform the coupon redemption terminal 1304 that the transaction was accepted and the discount applied so the coupon redemption terminal 1304 can inform the mobile device 210 and, optionally, the E-Coupon Manager 212, step 1534. Notified that the transaction was accepted and the coupon discount applied, the mobile device 210 may store a status value in the corresponding E-Coupon data record as being cancelled, redeemed or deleted from the mobile device 210 so that it is not be used again for other transactions. Similarly, if the E-Coupon Manager 212 receives the notification and stores the transaction completion status in the coupon database.

In certain circumstances, it may be desirable to collect personal information of a consumer using a secured mobile device 210 at the time the E-Coupon is redeemed to inform the coupon owner 200 about the details of how, where, when, why and by whom the E-Coupon was used. In an embodiment, consumer information may be transferred from the mobile device 210 to the coupon redemption terminal 1304 along with the E-Coupon. The coupon redemption terminal 1304 (or the payment terminal 214) may transmit the consumer information to the E-Coupon Manager 212, the coupon clearinghouse 218, the coupon owner or another information collector. Such consumer information may be collected, stored and categorized to either be sold to advertisement companies or used in-house for marketing purposes.

Operation of the various embodiments including E-Coupon redemption may be illustrated by way of an example transaction. Consider the example of a consumer entering an electronics goods store to purchase a DVD. The consumer may first retrieve an E-Coupon for the DVD by tapping the consumer's mobile device 210 on a Smart Ad 1100 or to the DVD itself if the DVD has an RFID included in its packaging. The redeemable E-Coupon associated with the Smart Ad 1100 will be created and transmitted to the consumer's mobile device 210 automatically and with no actions by the consumer. The consumer then goes to the cashier to purchase the DVD and redeem the received E-Coupon. At the cashier, there may be two terminals: a payment terminal 214 and a coupon redemption terminal 1304.

In order to purchase the DVD, the consumer may use a credit card at the payment terminal 214 and redeem the E-Coupon by tapping the mobile device 210 on the coupon redemption terminal 1304 (assuming it is equipped with NFC technology). If the mobile device 210 is a high security device, the E-Coupon is retrieved from the mobile device's memory and the associated discount applied towards the DVD purchase. In this process the E-Coupon is recorded as redeemed or is deleted from the mobile device memory. If the mobile device 210 is a low security device, the coupon redemption terminal 1304 retrieves the unique E-Coupon ID stored on the mobile device 210 and sends it to the E-Coupon Manager 212. The unique E-Coupon ID is then marked as redeemed or is deleted from the mobile device memory. The E-Coupon Manager 212 checks the unique E-Coupon ID in its coupon database and sends the corresponding E-Coupon information to the coupon redemption terminal 1304 for processing. If the payment is authorized, the payment terminal 214 uses the E-Coupon information to discount the purchase price. If the payment is not authorized the coupon redemption terminal 1304 sends a restore request to the E-Coupon Manager 212 and the coupon redemption terminal 1304 updates the unique E-Coupon ID on the mobile device 210.

FIG. 16 is a component block diagram of an embodiment of a mobile device 210 suitable for use in the overview system. A typical mobile device 210 may include a microprocessor 1602, a memory 1604, an antenna 1608, a display 1610, an alphanumeric keypad 1612, a 4-way menu selector rocker switch 1614, a speaker 1616, a microphone 1618, a vocoder 1620, a cellular network transceiver 1622, and various circuits, busses and electrical interconnections among these components. The mobile device 210 may also include a wireless transceiver, such as WiFi transceiver 1636, and a near-field communication (NFC) transceiver 1640 may be incorporated to communicate with a variety of external networks. In addition, the mobile device 210 may also include sensors connected to the processor 1602 that can provide data which can be used to personalize E-Coupons. Such sensors may include a camera 1628, which in addition to taking pictures can be used to detect generic E-Coupon identifiers 206 in embedded in images and/or video transmissions. The mobile device 210 may also include a GPS receiver 1638 which is configured to receive signals from GPS satellites to determine the precise global position of the mobile device 210. It should be noted that while mobile device 210 is depicted in FIG. 16 as a mobile handset or cell phone, the components may be found in any mobile device with wireless communication capability. In this way, other mobile devices such as a laptop computer, PDA or similar devices may be used in the various embodiments. Also, not all of the components illustrated in FIG. 16 need be included within a mobile device 210. For example, the mobile device 210 may as simple as a near-field purchasing (NFC) device, such as an NFC equipped credit card or key chain fob, in which case the mobile device would not include a display or a keypad.

In the foregoing descriptions of the various embodiments reference is made to coupons related to “merchandise.” The word “merchandise” is used herein to refer to any form of commercial product or service that may be promoted through the use of coupons. It should be appreciated that the embodiments and the claims are not limited to coupons for merchandise per se and also encompass E-Coupons issued for commodities (e.g., gasoline and fuel oil), services (e.g., automobile oil changes and lawn services), professional services (e.g., eye examinations and tax preparation), travel (e.g., airline tickets and hotel accommodations), rentals (e.g., movie rentals), and financial services (e.g., banking services and stock brokering).

The steps of a method or algorithm described in connection with the embodiments disclosed herein may be embodied directly in hardware, in a software module executed by a processor, or in a combination of the two. A software module may reside in processor readable memory which may be any of RAM memory, flash memory, ROM memory, EPROM memory, EEPROM memory, registers, hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. Additionally, in some embodiments, the steps and/or actions of a method or algorithm may reside as one or any combination or set of codes and/or instructions on a machine readable medium and/or computer readable medium, which may be incorporated into a computer program product.

In one or more exemplary implementations, the functions described may be implemented in hardware, software, firmware, or any combination thereof. If implemented in software, the function may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray Disc® where disks usually reproduce data magnetically, while discs reproduce data optically with lasers. Combinations of the above should also be included within the scope of computer-readable media.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

I claim:

1. A method for distributing and personalizing electronic coupons (E-Coupons) comprising:
transmitting a generic E-Coupon identifier;
receiving the generic E-Coupon identifier along with a request for a redeemable E-Coupon;
creating a personalized redeemable E-Coupon based at least in part on the generic E-Coupon identifier; and
transmitting the personalized redeemable E-Coupon.

2. The method of claim 1, wherein:
the generic E-Coupon identifier is transmitted via a communication medium receivable by a mobile device;
the request for a redeemable E-Coupon is received from the mobile device; and
the personalized redeemable E-Coupon is transmitted to the mobile device.

3. The method of claim 1, wherein:
the generic E-Coupon identifier is transmitted via a first communication medium receivable by a mobile device;
the request for a redeemable E-Coupon is received from the mobile device via a second communication medium different from the second communication medium; and
the personalized redeemable E-Coupon is transmitted to the mobile device via the second communication medium.

4. The method of claim 1, further comprising:
receiving consumer information along with the request for a redeemable E-Coupon; and
creating the personalized redeemable E-Coupon based on the received consumer information.

5. The method of claim 1, further comprising:
receiving information on capabilities of a mobile device along with the request for a redeemable E-Coupon; and
creating the personalized redeemable E-Coupon based on the received information on capabilities of a mobile device.

6. The method of claim 1, wherein:
the generic E-Coupon identifier includes a unique merchandise ID corresponding to a specific merchandise; and
the personalized redeemable E-Coupon is for the merchandise associated with the unique merchandise ID.

7. The method of claim 6, wherein the generic E-Coupon identifier is transmitted by a radiofrequency identification (RFID) tag associated with the specific merchandise.

8. The method of claim 2, further comprising digitally signing the personalized E-Coupon before transmitting it to the mobile device.

9. The method of claim 2, further comprising:
associating a unique redeemable E-Coupon identifier with the personalized redeemable E-Coupon; and
storing the personalized redeemable E-Coupon in a database including the unique redeemable E-Coupon identifier,
wherein transmitting the personalized redeemable E-Coupon comprises transmitting the unique redeemable E-Coupon identifier to the mobile device.

10. The method of claim 3, wherein the first communication medium is watermarked sound.

11. The method of claim 3, wherein the first communication medium is watermarked video.

12. The method of claim 3, wherein the first communication medium is a watermarked image.

13. The method of claim 3, wherein the first communication medium is a wireless data network.

14. The method of claim 3, wherein the first communication medium is a near-field communication link.

15. The method of claim 3, wherein the second communication medium is a wireless data network.

16. The method of claim 3, wherein the second communication medium is a cellular telephone network.

17. The method of claim 3, wherein the second communication medium is a near-field or short-range wireless data link.

18. The method of claim 4, wherein the consumer information includes at least one from the group consisting of location, time, purchase history and consumer preferences.

19. The method of claim 5, wherein information on capabilities of a mobile device includes at least one parameter selected from the group consisting of display capabilities, processor capabilities, security capabilities, communication capabilities and loaded applications.

20. A method for receiving electronic coupons (E-Coupons) comprising:
receiving a generic E-Coupon identifier;
transmitting a request for a redeemable E-Coupon including at least a portion of the generic E-Coupon identifier;
receiving a redeemable E-Coupon; and
storing the receive redeemable E-Coupon in memory.

21. The method of claim 20, further comprising transmitting user information along with the request for a redeemable E-Coupon.

22. The method of claim 21, wherein the user information includes at least one from the group consisting of location, time, purchase history and consumer preferences.

23. The method of claim 20, wherein:
the generic E-Coupon identifier is received via a first communication medium receivable by a mobile device;
the request for a redeemable E-Coupon is transmitted via a second communication medium different from the second communication medium; and
the personalized redeemable E-Coupon is received via the second communication medium.

24. The method of claim 23, wherein the first communication medium is watermarked sound, further comprising receiving the watermarked sound with a microphone and processing the watermarked sound to extract the generic E-Coupon identifier.

25. The method of claim 23, wherein the first communication medium is a watermarked video, further comprising imaging the watermarked video with a camera and processing the image to extract the generic E-Coupon identifier.

26. The method of claim 23, wherein the first communication medium is a watermarked image, further comprising imaging the watermarked image with a camera and processing the image to extract the generic E-Coupon identifier.

27. The method of claim 23, wherein the first communication medium is a wireless data network.

28. The method of claim 23, wherein the first communication medium is a near-field communication link.

29. The method of claim 20, further comprising transmitting the redeemable E-Coupon to a coupon redemption terminal.

30. The method of claim 29, wherein the redeemable E-Coupon is transmitted to a coupon redemption terminal via a near-field communication link.

31. A mobile device, comprising:
a processor;
a first transceiver coupled to the processor; and
a memory coupled to the processor, wherein the processor is configured with software instructions to perform steps comprising:
receiving a generic E-Coupon identifier;
transmitting via the first transceiver a request for a redeemable E-Coupon including at least a portion of the generic E-Coupon identifier;
receiving via the first transceiver a redeemable E-Coupon; and
storing the receive redeemable E-Coupon in the memory.

32. The mobile device of claim 31, wherein the processor is configured with software instructions to perform steps further comprising transmitting user information along with the request for a redeemable E-Coupon.

33. The mobile device of claim 32, wherein the user information includes at least one from the group consisting of location, time, purchase history and consumer preferences.

34. The mobile device of claim 31, further comprising a microphone coupled to the processor,
wherein the processor is further configured with software instructions so that:
the generic E-Coupon identifier is received as watermarked sound; and
the generic E-Coupon identifier is extracted from the watermarked sound.

35. The mobile device of claim 31, further comprising a camera coupled to the processor,
wherein the processor is further configured with software instructions so that:
the generic E-Coupon identifier is extracted from a watermarked image that is imaged by the camera.

36. The mobile device of claim 31, further comprising a camera coupled to the processor,
wherein the processor is further configured with software instructions so that:
the generic E-Coupon identifier is extracted from a watermarked video display that is imaged by the camera.

37. The mobile device of claim 31, further comprising a second transceiver coupled to the processor,
wherein the processor is further configured with software instructions so that:
the generic E-Coupon identifier is received via the second transceiver; and
the second transceiver is configured to communicate with a communication technology different from the first communication medium.

38. The mobile device of claim 31, wherein the processor is configured with software instructions to perform steps further comprising transmitting information regarding the mobile device along with the request for a redeemable E-Coupon.

39. The mobile device of claim 31, wherein the processor is configured with software instructions to perform steps further comprising transmitting the redeemable E-Coupon to a coupon redemption terminal.

40. The mobile device of claim 31, further comprising a near field communication transceiver coupled to the processor, wherein the processor is configured with software instructions to perform steps further comprising transmitting the redeemable E-Coupon to the coupon redemption terminal via the near field communication transceiver.

41. A mobile device comprising:
means for receiving a generic E-Coupon identifier;
means for transmitting a request for a redeemable E-Coupon including at least a portion of the generic E-Coupon identifier; and
means for receiving a redeemable E-Coupon; and
means for storing the receive redeemable E-Coupon.

42. The device of claim 41, further comprising:
means for transmitting user information along with the request for a redeemable E-Coupon.

43. The device of claim 42, wherein the user information includes at least one from the group consisting of location, time, purchase history and consumer preferences.

44. The device of claim 41, further comprising means for extracting the generic E-Coupon identifier from watermarked sound.

45. The device of claim 41, further comprising means for extracting the generic E-Coupon identifier from a watermarked image.

46. The device of claim 41, further comprising means for extracting the generic E-Coupon identifier from a watermarked video image.

47. The device of claim 41, further comprising means for receiving the generic E-Coupon identifier from a radiofrequency identification (RFID) tag.

48. The device of claim 41 wherein the means for receiving the generic E-Coupon identifier and the means for receiving the redeemable E-Coupon employ different communication technologies.

49. The device of claim 41, further comprising means for transmitting the redeemable E-Coupon to the coupon redemption terminal via the near field communication transceiver.

50. A tangible storage medium having stored thereon processor-executable software instructions configured to cause a mobile device processor to perform steps comprising:
receiving a generic E-Coupon identifier;
transmitting a request for a redeemable E-Coupon including at least a portion of the generic E-Coupon identifier;
receiving a redeemable E-Coupon; and
storing the receive redeemable E-Coupon.

51. The tangible storage medium of claim 50, wherein the stored processor-executable software instruction are configured to cause a mobile device processor to perform further steps comprising:
transmitting user information along with the request for a redeemable E-Coupon.

52. The tangible storage medium of claim 51, wherein the user information includes at least one from the group consisting of location, time, purchase history and consumer preferences.

53. The tangible storage medium of claim 50, wherein the stored processor-executable software instruction are configured to cause a mobile device processor to perform further steps comprising:
receiving the E-Coupon signed using a cryptographic or digital signature.

54. The tangible storage medium of claim 50, wherein the stored processor-executable software instruction are configured to cause a mobile device processor to perform further steps comprising extracting the generic E-Coupon identifier from watermarked sound.

55. The tangible storage medium of claim 50, wherein the stored processor-executable software instruction are configured to cause a mobile device processor to perform further steps comprising extracting the generic E-Coupon identifier from a watermarked image.

56. The tangible storage medium of claim 50, wherein the stored processor-executable software instruction are configured to cause a mobile device processor to perform further steps comprising extracting the generic E-Coupon identifier from watermarked video image.

57. The tangible storage medium of claim 50, wherein the stored processor-executable software instruction are configured to cause a mobile device processor to receive the generic E-Coupon identifier from a radiofrequency identification (RFID) tag.

58. The tangible storage medium of claim 50, wherein the stored processor-executable software instruction are configured to cause a mobile device processor to perform further steps comprising:
transmitting the redeemable E-Coupon to the coupon redemption terminal via the near field communication transceiver.

59. A server configured to distribute and personalize an E-Coupon and receive and transmit data via a network, comprising:
a server memory having stored thereon an E-Coupon database;
a server processor coupled to the server memory; and a network connection coupled to the server processor,
wherein the server processor is configured with software instructions to perform steps comprising:
receiving a generic E-Coupon identifier along with a request for a redeemable E-Coupon;
creating a personalized redeemable E-Coupon based at least in part on the generic E-Coupon identifier; and
transmitting the personalized redeemable E-Coupon.

60. The server of claim 59, wherein the server processor is configured with software instructions to receive the request for a redeemable E-Coupon from a mobile device, and transmit the personalized redeemable E-Coupon to the mobile device.

61. The server of claim 59, wherein the server processor is configured with software instructions to perform further steps comprising:
receiving consumer information along with the request for a redeemable E-Coupon; and
creating the personalized redeemable E-Coupon based on the received consumer information.

62. The server of claim 59, wherein:
the generic E-Coupon identifier includes a unique merchandise ID corresponding to a specific merchandise; and
the personalized redeemable E-Coupon is for the merchandise associated with the unique merchandise ID.

63. The server of claim 59, wherein the server processor is configured with software instructions to perform further steps comprising:
digitally signing the personalized E-Coupon before transmitting it to the mobile device.

64. The server of claim 59, wherein the server processor is configured with software instructions to perform further steps comprising:
associating a unique redeemable E-Coupon identifier with the personalized redeemable E-Coupon; and
storing the personalized redeemable E-Coupon in a database including the unique redeemable E-Coupon identifier,
wherein transmitting the personalized redeemable E-Coupon comprises transmitting the unique redeemable E-Coupon identifier to the mobile device.

65. The server of claim 64, wherein the server processor is configured with software instructions to perform further steps comprising:
receiving the unique redeemable E-Coupon identifier from a coupon redemption terminal in a request to redeem the personalized redeemable E-Coupon;
recalling the personalized redeemable E-Coupon from the database using the received unique redeemable E-Coupon identifier; and
transmitting information regarding the personalized redeemable E-Coupon to the coupon redemption terminal.

66. The server of claim 65, wherein the server processor is configured with software instructions to perform further steps comprising determining if the personalized redeemable E-Coupon is valid, wherein the step of transmitting information regarding the personalized redeemable E-Coupon to the coupon redemption terminal is performed only if the personalized redeemable E-Coupon is valid.

67. The server of claim 65, wherein the server processor is configured with software instructions to perform further steps comprising determining if the personalized redeemable E-Coupon is valid, wherein the step of transmitting information regarding the personalized redeemable E-Coupon to the coupon redemption terminal is performed only if the personalized redeemable E-Coupon is valid.

68. The server of claim 65, wherein the server processor is configured with software instructions to perform further steps comprising:
receiving notification that a transaction related to the redeemable personalize redeemable E-Coupon was completed; and
storing an indication in the database that the personalized redeemable E-Coupon is invalid in response to receiving the notification.

69. A server, comprising:
means for receiving a generic E-Coupon identifier along with a request for a redeemable E-Coupon;
means for creating a personalized redeemable E-Coupon based at least in part on the generic E-Coupon identifier; and
means for transmitting the personalized redeemable E-Coupon.

70. The server of claim 69, further comprising:
means for transmitting the personalized redeemable E-Coupon to a mobile device.

71. The server of claim 69, further comprising:
means for receiving consumer information along with the request for a redeemable E-Coupon; and
means for creating the personalized redeemable E-Coupon based on the received consumer information.

72. The server of claim 70, further comprising:
means for digitally signing the personalized E-Coupon before transmitting it to the mobile device.

73. The server of claim 70, further comprising:
means for creating the E-Coupon further based on user- and device-specific data.

74. The server of claim 70, further comprising:
means for associating a unique redeemable E-Coupon identifier with the personalized redeemable E-Coupon; and
means for storing the personalized redeemable E-Coupon in a database including the unique redeemable E-Coupon identifier,
wherein the means for transmitting the personalized redeemable E-Coupon comprises means for transmitting the unique redeemable E-Coupon identifier to the mobile device.

75. The server of claim 69, further comprising:
means for receiving the unique redeemable E-Coupon identifier from a coupon redemption terminal in a request to redeem the personalized redeemable E-Coupon;
means for recalling the personalized redeemable E-Coupon from the database using the received unique redeemable E-Coupon identifier; and
means for transmitting information regarding the personalized redeemable E-Coupon to the coupon redemption terminal.

76. The server of claim 75, further comprising:
means for determining if the personalized redeemable E-Coupon is valid,
wherein the step of transmitting information regarding the personalized redeemable E-Coupon to the coupon redemption terminal is performed only if the personalized redeemable E-Coupon is valid.

77. The server of claim 75, further comprising means for determining if the personalized redeemable E-Coupon is valid, wherein the step of transmitting information regarding the personalized redeemable E-Coupon to the coupon redemption terminal is performed only if the personalized redeemable E-Coupon is valid.

78. The server of claim 75, further comprising:
means for receiving notification that a transaction related to the redeemable personalize redeemable E-Coupon was completed; and
means for storing an indication in the database that the personalized redeemable E-Coupon is invalid in response to receiving the notification.

79. A tangible storage medium having stored thereon, server-executable software instructions configured to cause the server to perform steps comprising:
receiving a generic E-Coupon identifier along with a request for a redeemable E-Coupon;
creating a personalized redeemable E-Coupon based at least in part on the generic E-Coupon identifier; and
transmitting the personalized redeemable E-Coupon.

80. The tangible storage medium of claim 79, wherein the stored server-executable software instructions configured to cause the receive the request for a redeemable E-Coupon from a mobile device, and transmit the personalized redeemable E-Coupon to the mobile device.

81. The tangible storage medium of claim 79, wherein the stored server-executable software instructions configured to cause the server to perform further steps comprising:
receiving consumer information along with the request for a redeemable E-Coupon; and
creating the personalized redeemable E-Coupon based on the received consumer information.

82. The tangible storage medium of claim 79, wherein the stored server-executable software instructions configured to cause the server to perform further steps comprising:
digitally signing the personalized E-Coupon before transmitting it to the mobile device.

83. The tangible storage medium of claim 79, wherein the stored server-executable software instructions configured to cause the server to perform further steps comprising:
creating the E-Coupon further based on the user and device specific data.

84. The tangible storage medium of claim 79, wherein the stored server-executable software instructions configured to cause the server to perform further steps comprising:
associating a unique redeemable E-Coupon identifier with the personalized redeemable E-Coupon; and
storing the personalized redeemable E-Coupon in a database including the unique redeemable E-Coupon identifier,
wherein transmitting the personalized redeemable E-Coupon comprises transmitting the unique redeemable E-Coupon identifier to the mobile device.

85. The tangible storage medium of claim 79, wherein the stored server-executable software instructions configured to cause the server to perform further steps comprising:
receiving the unique redeemable E-Coupon identifier from a coupon redemption terminal in a request to redeem the personalized redeemable E-Coupon;
recalling the personalized redeemable E-Coupon from the database using the received unique redeemable E-Coupon identifier; and
transmitting information regarding the personalized redeemable E-Coupon to the coupon redemption terminal.

86. The tangible storage medium of claim 79, wherein the stored server-executable software instructions configured to cause the server to perform further steps comprising:
comprising determining if the personalized redeemable E-Coupon is valid, wherein the step of transmitting information regarding the personalized redeemable E-Coupon to the coupon redemption terminal is performed only if the personalized redeemable E-Coupon is valid.

87. The tangible storage medium of claim 79, wherein the stored server-executable software instructions configured to cause the server to perform further steps comprising:
receiving notification that a transaction related to the redeemable personalize redeemable E-Coupon was completed; and
storing an indication in the database that the personalized redeemable E-Coupon is invalid in response to receiving the notification.

88. A system for distributing and redeeming personalize E-Coupons, comprising:
a first communication system configured to broadcast a generic E-Coupon identifier;
a mobile device configured to receive the generic E-Coupon identifier and transmit a request for redeemable E-Coupon including at least a portion of information contained in the generic E-Coupon identifier using a communication network different from the first communication system;
a server configured with software instructions to receive the request for a redeemable E-Coupon, create a personalized redeemable E-Coupon in response, and transmit the personalized redeemable E-Coupon to the mobile device; and
a coupon redemption terminal configured to receive the personalized redeemable E-Coupon from the mobile device in a redemption process.

89. The system of claim 88, wherein the first communication system comprises a sound system configured to broadcast a watermarked sound.

90. The system of claim 88, wherein the first communication system comprises a video system configured to broadcast a watermarked video image.

91. The system of claim 88, wherein the first communication system comprises a radiofrequency identification tag.

92. The system of claim 88, wherein the first communication system comprises a near field communication transceiver.
